(19) United States
(12) Patent Application Publication
(10) Pub. No.: US 2023/0376186 A1
(43) Pub. Date: Nov. 23, 2023

(54) STICKERS THAT INCORPORATE IDENTITY

(71) Applicant: Meta Platforms, Inc., Menlo Park, CA (US)

(72) Inventors: Ted Stephen Boda, San Jose, CA (US); Andrew Swerdlow, San Francisco, CA (US)

(21) Appl. No.: 17/737,529

(22) Filed: May 5, 2022

(51) Int. Cl. G06F 3/04845; G06F 3/04817; G06F 3/0482; H04L 51/10

(52) U.S. Cl. CPC G06F 3/04845; G06F 3/04817; G06F 3/0482; H04L 51/10

(57) ABSTRACT

Techniques for customizing stickers are described. For example, a social networking system may cause presentation, via a first interface, of a sticker tray associated with an account and may then receive, from the account, an indication of a selection of a sticker in the sticker tray. Based at least in part on the selection, the social networking system may cause presentation of an option to modify the sticker and may receive, from the account, an indication of a selection to modify the sticker. Based at least in part on the selection to modify the sticker, the social networking system may cause presentation of a second interface, including a control usable to modify the sticker. The social networking system may receive user input via the control to modify the sticker and, in some examples, may store the one or more modifications in association with a modified sticker in the sticker tray.

### BACKGROUND

Digital platforms such as text messaging, instant messaging, email, social media, gaming, or other applications by which users can share content provide users with numerous benefits and opportunities. For instance, users may create and share information, media, and other types of content with family, friends, colleagues, and even strangers. However, the freedom associated with creating and sharing content via these digital platforms is not without problems. Oftentimes, users may be limited in their ability to customize content items. Additionally, it may be cumbersome for users to share this same content across multiple platforms. For example, a user may wish to share similar items of content with different groups of people across various social medial platforms. Existing techniques to allow users to share content across various social media platforms are limited.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical components or features.

FIG. 1 is a schematic view of an example system usable to implement example techniques described herein.

FIGS. 2A-2C illustrate example interfaces usable for adding a sticker to a content item.

FIGS. 3A-3F illustrate example interfaces usable for creating a modified sticker in a sticker interface.

FIG. 4 illustrates an example interface usable to access and modify saved stickers.

FIGS. 5A-5E illustrate example interfaces usable for sharing modified stickers with other accounts of a social networking system.

FIG. 6 illustrates an example interface usable for accessing recommended stickers.

FIGS. 7A-7C illustrate example interfaces usable for sharing a modified sticker from a first platform to a second platform.

FIGS. 8A-8C illustrate example interfaces usable for enabling sharing of a second sticker to a second platform.

FIG. 9 illustrates an example interface usable for confirmation of sharing a second sticker to a second platform.

FIGS. 10A-10C illustrate example interfaces usable for modifying a second sticker on a second platform.

FIG. 11 illustrates an interface usable for sharing a third sticker to a third platform.

FIG. 12 illustrates an example process for modifying a sticker.

FIG. 13 illustrates an example process for generating preferred stickers based at least in part on implicit signals.

FIG. 14 illustrates an example process for sharing a first sticker on a first platform as a second sticker on a second platform.

FIG. 15 illustrates an example system and device which may be used to implement the techniques described herein.

### DETAILED DESCRIPTION

As discussed above, the ability to create and customize content shared on digital platforms may present challenges. For instance, many social network applications and/or services (herein referred to as “social networking systems”) allow accounts to create and/or customize content to share with other accounts. One way in which accounts may customize content is by adding existing customizations provided by the social networking system. In some cases, these existing customizations may include stickers, such as graphic overlays, filters, extended reality elements, and other computer-generated elements. For example, a social networking system may generate various stickers for accounts to add as a decorative element to their content. However, while stickers may allow accounts to personalize their content, accounts typically have limited ability to edit or customize these elements.

Existing options for customizing stickers have been inadequate. For instance, the current techniques allow accounts to customize stickers by changing a size or an orientation of the sticker as a whole. However, accounts lack an ability to further personalize the sticker, such as by altering an element of the sticker, rather than the sticker as a single, static unit. Additionally, accounts are limited in their ability to share stickers with other accounts, discouraging accounts from creating and engaging with one another. Moreover, current techniques for sharing stickers, modified or otherwise, are lacking as well. For example, an account may wish to add a sticker to multiple social media platforms. However, current techniques require the account to manually add an individual sticker to each platform, requiring time and computing power. Furthermore, stickers available on one platform may not be available on another platform. Thus, accounts are limited in their creative expression as they curate and share content.

This application describes techniques for allowing content creators the ability to customize, save, and/or share stickers. For instance, the techniques described herein may allow accounts to modify default or stock graphic design elements provided by a social networking account (herein referred to as “stickers”), share the modified stickers with other accounts of a social networking system, and share stickers (modified and/or unmodified) across multiple social networking platforms. The modifications to the stickers may be made based on explicit input from the user or account and/or implicit input or signals associated with the user or account based on information associated with the account (e.g., preferences, settings, demographic information, usage information, social network connections, search history, content sharing history, comment history, etc.).

These techniques allow users posting content the ability and creativity to modify generic stickers and share those modified stickers with other accounts, allowing accounts to further express their creativity via content generation. Moreover, by populating stickers across various platforms, these techniques allow users to easily and effortlessly apply stickers or other graphical elements to various platforms which may or may not be related, reducing user time and computing power, creating a cohesive and seamless social presence.

For instance, consider a first example where a user associated with an account is posting content to be shared on social media via a first platform indicating that the user received a vaccination. The user may, via a sticker tray of the first platform, select a stock “I got vaccinated” sticker provided by a social networking system. However, the user may wish to change the colors of the stock sticker. Thus, the second platform may provide an interface usable for the user to customize various elements of the stock sticker, such as a color, a type of font, a color of font, a size, etc. The user may save the customized sticker to later customize and/or may share the customized sticker to other accounts associated with other users.

Continuing with the example provided above, consider a second example in which the user wishes to further share the customized sticker to a second platform. The second platform may be administered by the same entity as the first platform or may be administered by separate/unrelated entities. For example, the user may have an account on two platforms offered by the same company, or two separate unrelated platforms offered by separate companies. Thus, the user, either on the first platform or the second platform, may decide to share the modified sticker to the second platform. Further, sharing stickers on the second platform may appear different than the first platform. For example, applying the modified sticker to the first platform may include adding the “I got vaccinated” graphic overlay to a two-dimensional graphic content item. However, the second platform may include three-dimensional objects, such as in an extended reality environment. Thus, applying the modified “I got vaccinated” sticker to the second platform may include adding a computer generated bandage to the arm of an avatar associated with the user, indicating that the user recently received a vaccine.

As used herein, an extended reality environment can include virtual reality, mixed reality, augmented reality, or other computer-generated environments. Extended reality elements refer to two- or three-dimensional computer-generated images or objects that are presented in, overlaid on, or otherwise associated with an extended reality environment. Users can access an extended reality environment using a computing device, such as a wearable device (e.g., a headset, glasses, watch, etc.), a computer, a mobile device (e.g., phone or tablet), a gaming device, or various other computing devices. The computing device used to access the extended reality environment can be implemented as a standalone computing device comprising substantially all functionality in a single device, or can be coupled via wired or wireless connection to one or more other computing devices (e.g., PCs, servers, gateway devices, coprocessors, etc.), peripheral devices, and/or input/output devices.

These and other aspects are described further below with reference to the accompanying drawings. The drawings are merely example implementations and should not be construed to limit the scope of the claims. For example, while examples are illustrated in the context of a user interface for a mobile device, the techniques may be implemented using any computing device and the user interface may be adapted to the size, shape, and configuration of the particular computing device. Also, while many of the examples are given in the context of modified stickers, the techniques described herein may also be applied to any type of visual element (e.g., graphic overlay, filter, extended reality element, avatar, etc.) which may be generated and shared on social networking systems.

### EXAMPLE SYSTEM ARCHITECTURE

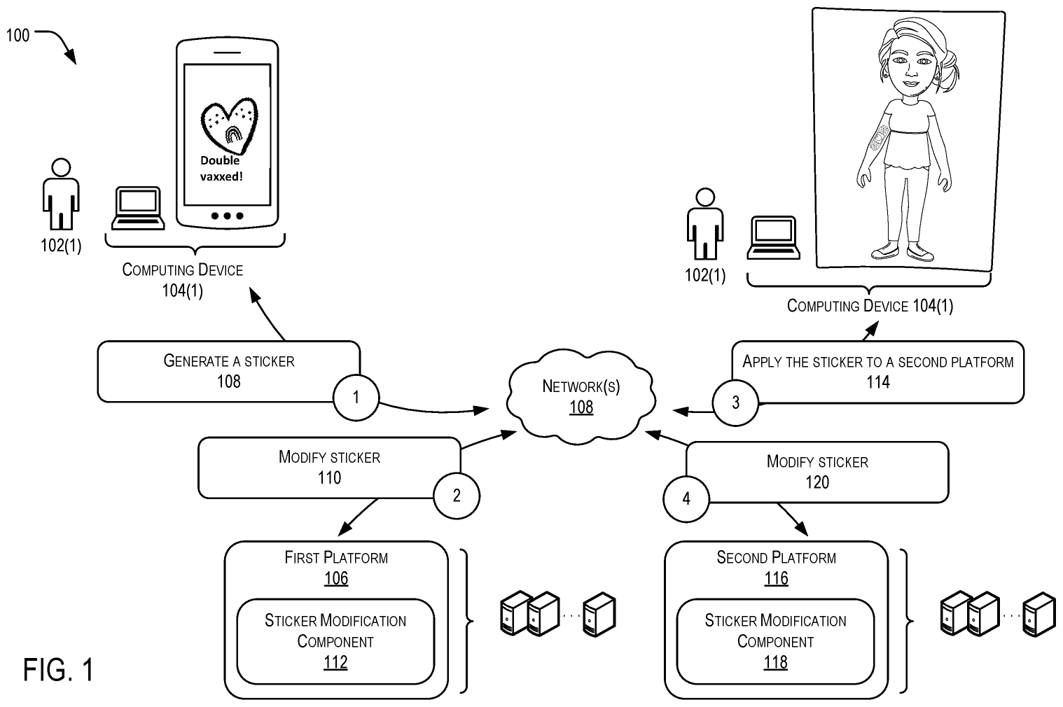

FIG. 1 is a schematic view of an example computing system 100 usable to implement example techniques described herein the ability to customize, share and/or populate content items, such as stickers, across multiple platforms. In some examples, the computing system 100 may include accounts 102(1), 102(2), . . . 102(n) (collectively “accounts 102”) that are associated with users and interact using computing devices 104(1), 104(2), . . . 104(m) (collectively “computing devices 104”) with a social networking system via a network 108. In this example, n and m are non-zero integers greater than 1.

Each of the computing devices 104 includes one or more processors and memory storing computer executable instructions to implement the functionality discussed herein attributable to the various computing devices. In some examples, the computing devices 104 may include desktop computers, laptop computers, tablet computers, mobile devices (e.g., smart phones or other cellular or mobile phones, mobile gaming devices, portable media devices, etc.), wearable devices (e.g., extended reality devices such as headsets or glasses, watches, etc.), or other suitable computing devices. The computing devices 104 may execute one or more client applications, such as a web browser (e.g., Microsoft Windows Internet Explorer, Mozilla Firefox, Apple Safari, Google Chrome, Opera, etc.) or a native or special-purpose client application (e.g., social media applications, messaging applications, email applications, games, etc.), to access and view content over the network 108.

The network 108 may represent a network or collection of networks (such as the Internet, a corporate intranet, a virtual private network (VPN), a local area network (LAN), a wireless local area network (WLAN), a cellular network, a wide area network (WAN), a metropolitan area network (MAN), or a combination of two or more such networks) over which the computing devices 104 may access the social networking system 106 and/or communicate with one another.

The social networking system may include one or more servers or other computing devices, any or all of which may include one or more processors and memory storing computer executable instructions to implement the functionality discussed herein attributable to the social networking system or digital platform. The social networking system may enable accounts 102 associated with its users (such as persons or organizations) to interact with the social networking system and with each other via the computing devices 104. The social networking system may, with input from a user, create and store in the social networking system a user account associated with the user. The user account may include demographic information, communication-channel information, financial information, and/or information on personal interests of the user. The social networking system may also, with input from a user, create and store a record of relationships of the user with other users of the social networking system, as well as provide services (e.g., posts, comments, photo-sharing, messaging, tagging, mentioning of other users or entities, games, etc.) to facilitate social interaction between or among the accounts 102.

At operation 108 (indicated by “1”), a first platform 106 of the social networking system may generate a sticker. While the current illustration describes the first platform 106 and a second platform 116 generating, modifying, and sharing stickers, the techniques described herein are not limited to platforms, and any element of the social networking system may perform such actions. A sticker may include a graphic design element which may be added to a content item of the social networking system to increase aesthetic appeal and/or foster engagement with other accounts 102. Stickers may be accessible via one or more platforms associated with the social networking system and may be available for accounts 102 of the social networking system to use. As one example, a sticker may be a static sticker, such as an emoji or an image, which may overlay a content item.

Alternatively, a sticker may be an interactive sticker, which may include a selectable icon or other interactive element, such as a GIF or an extended reality element. For example, an interactive sticker may be a donation sticker (allowing accounts 102 to donate money to as fundraisers), a quiz sticker (allowing accounts 102 to answer a multiple choice poll) a question sticker (allowing accounts 102 to respond to enter text in response to a question), a countdown sticker (displaying a date countdown to an event), a music sticker (adding a song, song lyrics, and/or audio), a location sticker (sharing a location of an account 102); a hashtag sticker (adding a selectable hashtag), an image sticker (displaying an image or video from a camera roll or taken by a device 104 associated with an account 102), a time sticker (displaying a current time associated with a location of an account 102), or a weather sticker (displaying a weather and/or temperature of a location associated with a location of an account 102), to name a few non-limiting examples.

In some examples, such as at operation 110 (indicated by “2”) the sticker may be modified on a first platform 106 and by a user associated with a first account 102(1). For example, the first platform 106 may cause presentation, via a first interface, of a sticker tray associated with a first account 102(1) of the first platform 106. In some examples, the sticker tray may include one or more stickers. The one or more stickers, for example, may be generated by the first platform 106. Additionally or alternatively, the one or more stickers may be generated by accounts 102 of the first platform 106, other social networking applications, and/or third-party applications.

In some examples, the first platform 106 may receive, from the first account 102(1), an indication of a selection of a sticker in the sticker tray. Based at least in part on the indication, the first platform 106 may cause presentation of an option to modify the sticker. The first platform 106 may then receive, from the first account 102(1), an indication of a selection to modify the sticker. Based at least in part on the selection to modify the sticker, the first platform 106 may cause presentation of a second interface. In some examples, the second interface may be different than the first interface and may include one or more controls usable to modify the sticker. Based at least in part on receiving one or more modifications, a sticker modification component 112 of the first platform 106 may generate a modified sticker.

Modifications may include any change to one or more elements of the sticker. For example, a sticker may have multiple elements, such as one or more shapes, texts, or images. Thus, a modification to an element may include a change to a font (e.g., a change in a font type, a font color, a font size, a text of a font, an alignment of a text, etc.), a change to a shape (e.g., a change in a shape size, a shape color, a shape outline, etc.), or a change to an image (e.g., an image type, an image filter, an image size, an image opacity, an etc.). Modifications may also include a change to a relationship between elements, such as bringing an element to a foreground or moving an element to a background or animating an element.

In some examples, modifications may include an addition to and/or a removal of an element. For example, a modification may include an addition of a drawing (e.g., a free-hand drawing), an addition of audio (e.g., at least a portion of a song, a voice recording, etc.), an addition of a new sticker, or a removal of at least a portion of an element, to name a few examples. The modification can be based on explicit user input and/or can be performed automatically based on implicit input or signals previously received based on the user's interaction with the account (e.g., preferences, settings, demographic information, usage information, social network connections, search history, content sharing history, comment history, etc.). In some examples, the social networking system may store the one or more modifications in association with a modified sticker in the sticker tray, allowing the first account 102(1) to access and share the modified sticker.

In some examples, the first account 102(1) may add the modified sticker to one or more content items, such as a post, an item of ephemeral, content (e.g., a story), or a reel, to name a few non-limiting examples. For example, the first platform 106 may receive, from the first account 102(1), an indication to add the modified sticker to a content item. The first platform 106 may then cause presentation, via a display of a computing device 104(2) associated with a second account 102(2) of the first platform 106, of the content item including the modified sticker.

In some examples, the first account may share the modified sticker with other accounts 102(2)-102(n) of the social networking system. For example, the first platform 106 may receive, from the first account 102(1), an indication to share the modified sticker. The first platform 106 may then receive, from the first account 102(1), an indication to send the modified sticker to a second account 102(2) of the social networking system. In response to receiving the indication, the first platform 106 may then send, to the second account 102(2), the modified sticker. In response to receiving the modified sticker, the second account 102(2) may apply the modified stickler to a content item. For example, the first platform 106 may receive, from the second account 102(2), an indication to add the modified sticker to a second content item. Based at least in part on receiving the indication, the first platform 106 may then cause presentation, via a display of a computing device 104(3) associated with a third account 102(3) of the first platform 106, of the second content item including the modified sticker.

While a user of an account 102 may wish to share a customized sticker, the account 102 may wish to place limitations on the use of the customized sticker, such as a time limitation. For example, based at least in part on receiving an indication from the first account 102(1) to send the modified sticker to the second account 102(2), the first platform 106 may cause presentation of a selectable icon. The selectable icon may be presented via the first interface may enable the first account 102(1) to limit an amount of time that the modified sticker is accessible by the second account 102(2). The first platform 106 may then receive, from the first account 102(1), an indication of an amount of time (e.g., 1 hour, 24 hours, 1 week, etc.), wherein causing presentation of the content item via the display of the computing device 104(3) associated with the third account 102(3) is based at least in part on the amount of time.

In other examples, the first account 102(1) may wish to limit other accounts' 102(2)-102(n) abilities to make additional modifications to the modified sticker. For example, based at least in part on receiving an indication to send the modified sticker to the second account 102(2), the first platform 106 may cause presentation of a selectable icon which may enable the first account 102(1) to limit an amount of further customizations which may be made to the modified sticker. For example, similar to that described above with respect to limiting an amount of time, the selectable icon may be presented via the first interface. In some examples, limiting modifications may include limiting an element or characteristic that may be modified (e.g., allowing certain elements to be modified), limiting a type of modification (e.g., allowing only certain types of modifications to take place, such as changing a font type or color), or limiting a number of modifications that may be made (e.g., 1 modification, 5 modifications, etc.).

Consider, as an illustrative example, a customized “Happy Birthday” sticker. For example, a user of a first account 102(1) may wish to customize a “Happy Birthday” sticker for a user of the second account 102(2) (Account 2), who may be celebrating a birthday. The first account 102(1) may select, from a sticker tray on the first platform, a generic “Happy Birthday” sticker. The first account 102(1) may then modify the content of the font to say, “Happy Birthday Account 2,” and may change the color of the font to a favorite color of the second account 102(2). The first account 102(1) may then save the modified sticker and add it to a photo of the second account 102(2) and share the content item as a story. In some examples, a third account 102(3) may also want to wish happy birthday to the second account 102(2) via a story and may wish to use the modified sticker. Thus, the first account 102(1) may send the modified sticker to the third account 102(3). However, the first account 102(1) may set a 24-hour time limit on the modified sticker, such that it cannot be used after the birthday of the user of the second account 102(2).

In some examples, the first platform 106 may recommend stickers, herein referred to as “preferred stickers,” to the first account 102(1). The preferred stickers may include stickers that have been customized for the first account based at least in part on implicit and/or explicit signals from or associated with the first account 102(1). An implicit signal may be a signal derived or inferred from an action performed by the first account 102(1), such as liking or commenting on a post. Conversely, an explicit signal may be a signal derived from information affirmatively given by the first account 102(1), such as a list of preferences. For example, the first platform 106 may store the one or more modifications as a preference of the first account. The first platform 106 may then generate, based at least in part on the one or more modifications, one or more preferred stickers. The first platform 106 may, in some examples, store the one or more preferred stickers in the sticker tray. Similar to the first sticker, the one or more preferred stickers may be added to a content item to be shared with a second account. Additionally, the preferred stickers may be, in some examples, modified and/or sent to second accounts.

As an illustrative example, consider a first sticker having a first font, herein referred to as Font 1. A user associated with a first account 102(1) may select the sticker with Font 1, but may prefer a different font, herein referred to as Font 2. Thus, the user associated with the first account 102(1) may affirmatively change, via the second interface, Font 1 to Font 2. This is an example of an explicit preference. Based at least in part on this change and one or more other actions taken by the user, the first platform 106 may infer that the user of the first account 102(1) prefers Font 2 as opposed to Font 1 and may store Font 2 as a preferred font. This is an example of an implicit preference. Thus, the social networking system 106 may generate preferred stickers with Font 2, as opposed to Font 1, based at least in part on the previous interactions of the first account 102(1).

Additionally or alternatively, the first platform 106 may determine one or more inferred preferences based at least in part on interactions by the user account with one or more content items. For example, first platform 106 may determine an interaction between the first account 102(1) and a second content item. An interaction may include a like, a comment, a share, a direct message, or a re-post, to name a few non-limiting examples. In some examples, the first platform 106 may determine a category associated with the second content item (e.g., dogs, healthy recipes, skiing, etc.). Based at least in part on the interaction, the first platform 106 may then determine a second preference, wherein the second preference may be associated with the category. The one or more stickers may then be generated based at least in part on the second preference, thus providing the first account 102(1) with stickers they are more likely to like and use.

In some examples, the first platform 106 may determine that a number of interactions is greater than a threshold number of interactions (e.g., 1 interaction, 5 interactions, 15 interactions, 100 interactions, etc.). In some examples, generating the one or more preferred stickers may be based at least in part on the number of interactions exceeding the threshold number of interactions. In this way, the first platform 106 may ensure that the preference is more likely to be of interest to the first account 102(1).

As another illustrative example, consider that a user associated with a first account 102(1) is a dog lover. The first platform 106 may receive multiple indications of the first account 102(1) liking photos of dogs, commenting on posts of dogs, and posting photos of dogs. Based at least in part on the interactions, the first platform 106 may determine that the first account 102(1) prefers dogs. Thus, the first platform 106 may generate one or more preferred stickers that include dogs, rather than for example, cats.

At operation 114 (indicated by “3”) the first platform 106 may cause the social networking system to apply the sticker to a second platform different than the first platform 106. While the current illustration describes applying a modified sticker, the techniques described herein are not limited to stickers, and any content item may be applied. In some examples, the second platform may be administered by a same entity as the first platform 106 (e.g., two different products offered by the same company), related entities (e.g., products offered by subsidiaries or affiliated companies), or by separate/unrelated entities. The second platform 116 may be of a same type as the first platform 106 (e.g., both the first platform 106 and the second platform 116 can be social networking platforms) or different types (e.g., a social networking platform and a gaming platform, or a video conferencing platform and a social networking platform, etc.).

In some examples, the first platform 106 and the second platform 116 may use a common or compatible file format or data structure to share stickers or other computer-generated elements across the platforms. In other examples, the first platform 106 and the second platform 116 may use different file formats or data structures to represent content, stickers, and other graphical elements on the respective platforms. In that case, a common or shared template may be provided which includes one or more predefined fields, layouts, tags, or other elements. By way of example and not limitation, the predefined elements may define a size, shape, dimension (e.g., 2D or 3D), position, pose (e.g., orientation in 2 or 3 dimensions), color, motion, sound, time (e.g., lifetime or expiration data), or other aspects describing or defining the characteristics of the graphical elements. The template may be used by the first platform 106 to populate or render the first graphical elements according to a first format associated with the first platform 106 (e.g., as a static 2D sticker), and the template may be used by the second platform 116 to populate or render the second graphical element according to a second format associated with the second platform 116 (e.g., as an avatar modification or accessory, as a 3D object, as a GIF or animation, etc.).

In some examples, the first platform 106 may receive, via the first platform 106 and from the first account 102(1), a request to apply a first sticker to a first content item. In some examples, the first content item may be associated with the first platform 106.

Based at least in part on receiving the request, the first platform 106 may then cause presentation of a prompt to apply a second sticker to the second platform 106. In some examples, the prompt may be displayed to the first account 102(1) via the first platform 106. In other examples, the prompt may be displayed to the first account 102(1) upon an indication that the first account 102(1) has accessed the second platform 106, such as logging into the second platform 116.

In some examples, the second platform 116 may be an application provided by the same social networking system as the first platform 106. However, in other examples, the first platform 106 and the second platform 116 may be unrelated. For example, the first platform 106 may be associated with separate social networking systems and/or one or more separate third-party applications.

In some examples, the first platform 106 and the second platform 116 may communicate with one another via computing devices locally or over a network, such as network 104. Examples of communication connections include, without limitation, Ethernet or other wired communication connections, cellular connections, RF (radio frequency) communication connections, or other wireless communication connections.

In some examples, the second sticker may be associated with the first sticker. For example, the first sticker and the second sticker may relate to a same concept or theme. In other examples, the first sticker and the second sticker may be platform specific instances of a same source sticker. Additionally or alternatively, the first sticker and the second sticker may be linked to a same source data structure maintained by at least one of the first platform, the second platform or a third platform. In other examples, the first platform 106, the second platform 116, and/or a third platform may use different file formats or data structures to represent content, stickers, and other graphical elements on the respective platforms. As discussed above, a common or shared template may be provided which includes one or more predefined fields, layouts, tags, or other elements. In some examples, the template may be used by the first platform 106 to populate or render the first graphical elements according to a first format associated with the first platform 106 (e.g., as a static 2D sticker), and the template may be used by the second platform 116 to populate or render the second graphical element according to a second format associated with the second platform 116 (e.g., as an avatar modification or accessory, as a 3D object, as a GIF or animation, etc.).

In some examples, the second platform 116 may then receive, via the first platform 106 and from the first account, an indication to apply the second sticker to the second platform 116.

Based at least in part on receiving the indication to apply the second sticker to the second platform 116, the first platform 106 may then cause a second instance of the sticker to be applied to a second content item associated with the second platform 116.

In some cases, the first platform 106 and/or the second platform 116 may provide a notification confirming whether an account 102 wishes to apply the second sticker to the second platform. For example, the second platform 116 may receive, from the first account 102(2) or a second account 102(1), a request to access the second platform 116. The request to access the second platform may include, for example, an indication that the first account 102(1) or the second account 102(2) has logged into and/or opened an application associated with the second platform. Based at least in part on receiving the request to access the second platform, the second platform 116 may cause presentation of a prompt to the first account 102(1) or the second account 102(2) to confirm the application of the second sticker to the second platform 116. In some examples, the prompt may be presented to the first account 102(1) and/or the second account 102(2) via the second platform 116 and may include a first selectable control to confirm or reject the application of the second sticker to the second platform 116. In response to receiving a confirmation to apply the second sticker to the second platform 116, the second platform 116 may maintain the application of the second sticker to the second platform 116. Alternatively, in response to receiving a rejection to apply the second sticker the second platform 116, the second platform 116 may remove the second sticker from the second platform 116 or refrain from applying the second sticker to the second platform 116.

In some cases, a user associated with an account 102 may wish to remove the second sticker from the second platform 116. Thus, the second platform 116 may receive, from the first account 102(1) or the second account 102(2), a request to remove the second sticker from the second platform 116. The second platform 116 may receive the request, for example, via at least one of the first platform 116 or the second platform 116. In response to receiving the request to remove the second sticker, the second platform 116 may remove the second sticker from the second platform 116. In some examples, in response to removing the second sticker from the second platform 116, the first platform 106 may automatically remove the first sticker from the first platform 106.

Alternatively, a user associated with an account 102 may wish to remove the first sticker from the first platform 106 while maintaining application of the second sticker on the second platform 116. For example, the first platform 106 and/or the second platform 116 may receive, from the first account 102(1) or the second account 102(2), a request to remove the first sticker from the first platform 106. The request may be received via the first platform or the second platform, for example. In response to receiving the request to remove the first sticker, the first platform 106 and/or the second platform 116 may remove the first sticker from the first platform 106. In some examples, in response to removing the first sticker from the first platform 106, the first platform 106 may cause presentation of an option to maintain the application of the second sticker on the second platform 116. The first platform 106 and/or the second platform 116 may present the option via at least one of the first platform 106 and/or the second platform 116, thus providing accounts the ability to control which platforms the first sticker and the second sticker are available.

In some examples, a time limit may be associated with the second sticker. For example, the second platform 116 may remove the second sticker from the second platform 116 after a predetermined period of time. In some examples, the period of time may be a default period of time (e.g., 12 hours, 24 hours, 1 week, 1 month, etc.) and may correspond with the second sticker. For example, a sticker associated with an event may be associated with a shorter period of time, while a sticker associated with a broader category may be for a longer or indefinite period of time. Thus, an “I Voted” sticker may have a period of time of 24 hours, or until the end of an election, while an “I Love Dogs” or “Shop Local” sticker may be perpetual, or until the first account 102(1) or the second account 102(2) removes and/or changes the sticker.

Additionally or alternatively, the period of time may be determined by the first account 102(1). For example, upon receiving an indication from the first account 102(1) to apply the second sticker to the second platform, the second platform 116 may present, to the first account 102(2) or the second account 102(2) and via the first platform 106 and/or the second platform 116, a prompt to set a time limit associated with the second sticker.

In some examples, a user associated with the first account 102(1) or the second account 102(2) may desire to add a third sticker to a third platform. For example, the first platform 106 and/or the second platform 116 may receive, from the first account 102(1) or the second account 102(2), a request to apply a third sticker to a third platform (not pictured). In some examples, the third platform may be the different than the first platform and/or the second platform. Additionally or alternatively, the third sticker may be different than and associated with the first sticker and/or the second sticker. Based at least in part on receiving an indication to apply the third sticker to the third platform, the first platform 106 and/or the second platform 116 may then apply a third instance of the sticker to a third content item associated with the third platform.

In some examples, the first sticker and/or the second sticker may be customized by at least one of the first account 102(1) and the second account 102(2). For example, the first platform 106 may receive, from the first account 102(1) and via the first platform 106, an indication of a selection to modify the first sticker. Based at least in part on the selection to modify the sticker, the first platform 106 may then cause presentation of an interface usable to modify the sticker. In some cases, the social networking system, 106 may then store the one or more modifications in association with a modified sticker. For example, the modified sticker may be the first sticker including one or more modifications to a font of the first sticker, a color of the first sticker, or a size of the first sticker, to name a few examples.

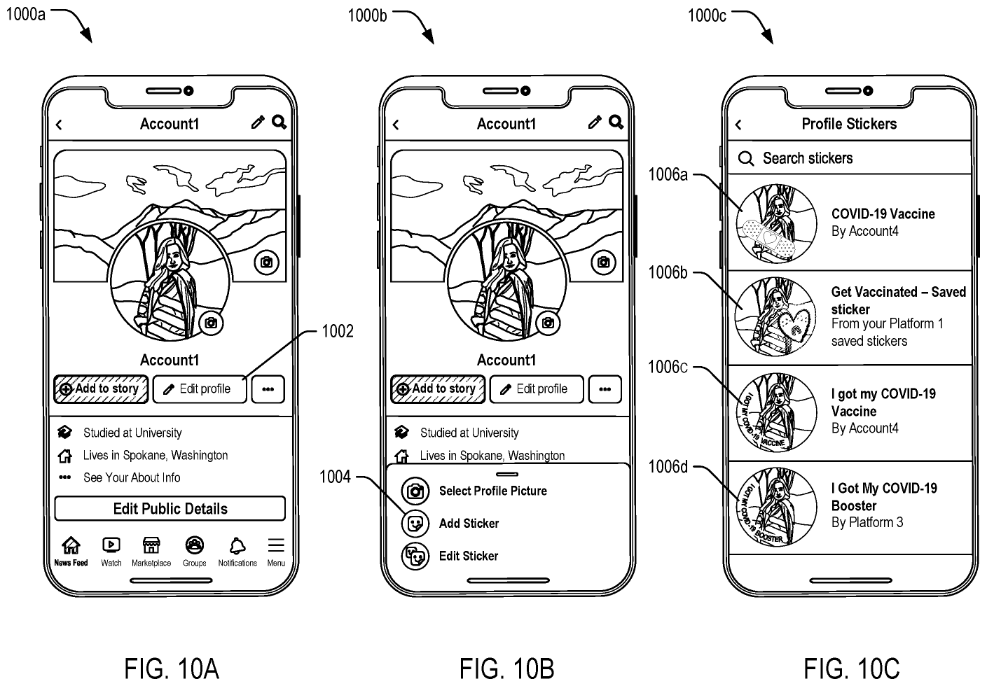

Additionally, or alternatively, such as at operation 120 (indicated by “4”) the second sticker may be modified in the second platform 116. For example, the second platform 116 may receive, from the first account 102(1) or the second account 102(2), a request to access the second platform 116. In response to receiving the request to access the second platform 116, the second platform 116 may then cause presentation, to the first account 102(1) or the second account 102(2), of an option to apply one or more customizations to the second sticker in the second platform 116. The social second platform 116 may then receive, from the first account 102(1) or the second account 102(2), a selection of the option to apply the one or more customizations. Customizations may be the same or similar to modifications which may be made to stickers, and can include, to name a few non-limiting examples, one or more modifications to a font of the first sticker, a color of the first sticker, or a size of the first sticker, to name a few examples. Additionally or alternatively, the customization may include an element, such as a third sticker, located on at least a portion of the second sticker, as described with more detail in reference to FIGS. 10A-10C.

In some cases, the modifications made to the second sticker on the platform may automatically apply to the first sticker. For example, in response to applying the one or more customizations to the second sticker on the second platform, the first platform 106 may apply the one or more customizations to the first sticker on the first platform.

Sharing content may take a variety of forms, such as a profile or feed post, a story, a direct message to one or more other accounts, a tweet, or a snap, to name a few examples. In general, a profile (or feed) post may include text and/or media content items, such as images, video, and/or audio. The profile post may be published to the social networking system 106 by an account, such as the first account 102(1), for consumption by other accounts 102(2)-102(n), and may be viewable by the other accounts 102(2)-102(n) for as long as the first account 102(1) is active and/or until the post is deleted by the first account 102(1), although examples are considered in which the profile post is removed and/or deleted after an amount of time (e.g., one hour, one day, one week, etc.). In some cases, a profile post shared by the first account 102(1) may be included in respective content feeds of other the accounts 102(2)-102(n) of the social networking system 106 that have “followed” the first account 102(1), are “friends” with the first account 102(1), are connections of the first account 102(1), or are otherwise associated with the account 102(1).

A story may be similar to a profile post, in that the story may include text and/or media content items, such as images, video, and/or audio, is published to the social networking system 106 by the first account 102(1) for consumption by the other accounts 102(2)-102(n), and may be included in a feed (although, in some cases, a separate feed from the profile post feed). However, a story may differ from a profile post in that the story may be shared only with a selected subset of the first account's 102(1) followers, and/or may be removed from being viewed by followers of the first account 102(1) after a certain period of time (e.g., one hour, one day, one week, etc.). A direct message may also include text and/or media content items, such as images, video, and/or audio, but in general, a direct message is shared with a single other account 102(n) of the social networking system 106, or a selected subset of other accounts 102(2)-102(n) of the social networking system 106 rather than shared with all of an account's 102 followers.

In some examples, the social networking system 106 may provide privacy features to the accounts 102. In particular examples, one or more objects (e.g., content or other types of objects) of the computing system 100 may be associated with one or more privacy settings. The one or more objects may be stored on or otherwise associated with any suitable computing system or application, such as, for example, the social networking system 106, a client system, a third-party system, a social networking application, a messaging application, a photo-sharing application, or any other suitable computing system or application. Although the examples discussed herein are in the context of an online social network, these privacy settings may be applied to any other suitable computing system. Privacy settings (or “access settings”) for an object or item of content may be stored in any suitable manner, such as, for example, in association with the object, in an index on an authorization server, in another suitable manner, or any suitable combination thereof. A privacy setting for an object may specify how the object (or particular information associated with the object) can be accessed, stored, or otherwise used (e.g., viewed, shared, modified, copied, executed, surfaced, or identified) within the online social network. When privacy settings for an object allow a particular account or other entity to access that object, the object may be described as being “visible” with respect to that account or other entity. As an example, and not by way of limitation, an account of the social networking system 106 may specify privacy settings for an account-profile page that identify a set of accounts that may access work-experience information on the account-profile page, thus excluding other accounts from accessing that information.

In particular examples, privacy settings for an object may specify a “blocked list” and/or a “restricted list” of accounts or other entities that should not be allowed to access certain information associated with the object. In particular examples, the blocked list may include third-party entities. The blocked list or restricted list may specify one or more accounts or entities for which an object is not visible. As an example, and not by way of limitation, an account may specify a set of accounts who may not access photo albums associated with the account, thus excluding those accounts from accessing the photo albums (while also possibly allowing certain accounts not within the specified set of accounts to access the photo albums). In particular examples, privacy settings may be associated with particular social-graph elements. Privacy settings of a social-graph element, such as a node or an edge, may specify how the social-graph element, information associated with the social-graph element, or objects associated with the social-graph element can be accessed using the online social network. As an example, and not by way of limitation, a particular concept node corresponding to a particular photo may have a privacy setting specifying that the photo may be accessed only by accounts tagged in the photo and friends of the accounts tagged in the photo. In particular examples, privacy settings may allow accounts to opt in to or opt out of having their content, information, or actions stored/logged by the social networking system 106 or shared with other systems (e.g., a third-party system). Although this disclosure describes using particular privacy settings in a particular manner, this disclosure contemplates using any suitable privacy settings in any suitable manner.

In particular examples, privacy settings may be based on one or more nodes or edges of a social graph. A privacy setting may be specified for one or more edges or edge-types of the social graph, or with respect to one or more nodes or node-types of the social graph. The privacy settings applied to a particular edge connecting two nodes may control whether the relationship between the two entities corresponding to the nodes is visible to other accounts of the online social network. Similarly, the privacy settings applied to a particular node may control whether the account or concept corresponding to the node is visible to other accounts of the online social network. As an example, and not by way of limitation, the first account 102(1) may share an object to the social networking system 106. The object may be associated with a concept node connected to an account node of the first account 102(1) by an edge. The first account 102(1) may specify privacy settings that apply to a particular edge connecting to the concept node of the object or may specify privacy settings that apply to all edges connecting to the concept node. As another example and not by way of limitation, the first account 102(1) may share a set of objects of a particular object-type (e.g., a set of images). The first account 102(1) may specify privacy settings with respect to all objects associated with the first account 102(1) of that particular object-type as having a particular privacy setting (e.g., specifying that all images posted by the first account 102(1) are visible only to friends of the first account 102(1) and/or accounts tagged in the images).

In particular examples, the social networking system 106 may present a “privacy wizard” (e.g., within a webpage, a module, one or more dialog boxes, or any other suitable interface) to the first account 102(1) to assist the first account 102(1) in specifying one or more privacy settings. The privacy wizard may display instructions, suitable privacy-related information, current privacy settings, one or more input fields for accepting one or more inputs from the first account 102(1) specifying a change or confirmation of privacy settings, or any suitable combination thereof. In particular examples, the social networking system 106 may offer a “dashboard” functionality to the first account 102(1) that may display, to the first account 102(1), current privacy settings of the first account 102(1). The dashboard functionality may be displayed to the first account 102(1) at any appropriate time (e.g., following an input from the first account 102(1) summoning the dashboard functionality, following the occurrence of a particular event or trigger action). The dashboard functionality may allow the first account 102(1) to modify one or more of the first account 102(1)'s current privacy settings at any time, in any suitable manner (e.g., redirecting the first account 102(1) to the privacy wizard).

Privacy settings associated with an object may specify any suitable granularity of permitted access or denial of access, including the “restrict” functionality described herein. As an example and not by way of limitation, access or denial of access may be specified for particular accounts (e.g., only me, my roommates, my boss), accounts within a particular degree-of-separation (e.g., friends, friends-of-friends), account groups (e.g., the gaming club, my family), account networks (e.g., employees of particular employers, students or alumni of particular university), all accounts (“public”), no accounts (“private”), accounts of third-party systems, particular applications (e.g., third-party applications, external websites), other suitable entities, or any suitable combination thereof. Although this disclosure describes particular granularities of permitted access or denial of access, this disclosure contemplates any suitable granularities of permitted access or denial of access.

In particular examples, one or more servers may be authorization/privacy servers for enforcing privacy settings. In response to a request from an account (or other entity) for a particular object stored in a data store, the social networking system 106 may send a request to the data store for the object. The request may identify the account associated with the request and the object may be sent only to the account (or a client system of the account) if the authorization server determines that the account is authorized to access the object based on the privacy settings associated with the object. If the requesting account is not authorized to access the object, the authorization server may prevent the requested object from being retrieved from the data store or may prevent the requested object from being sent to the account. In the search-query context, an object may be provided as a search result only if the querying account is authorized to access the object, e.g., if the privacy settings for the object allow it to be surfaced to, discovered by, or otherwise visible to the querying account. In particular examples, an object may represent content that is visible to an account through a newsfeed of the account. As an example, and not by way of limitation, one or more objects may be visible to an account's “Trending” page. In particular examples, an object may correspond to a particular account. The object may be content associated with the particular account or may be the particular account's account or information stored on the social networking system 106, or other computing system. As an example, and not by way of limitation, a first account 102(1) may view one or more second accounts of an online social network through a “People You May Know” function of the online social network, or by viewing a list of friends of the first account 102(1). As an example, and not by way of limitation, a first account 102(1) may specify that they do not wish to see objects associated with a particular second account in their newsfeed or friends list. If the privacy settings for the object do not allow it to be surfaced to, discovered by, or visible to the account, the object may be excluded from the search results. Although this disclosure describes enforcing privacy settings in a particular manner, this disclosure contemplates enforcing privacy settings in any suitable manner.

In particular examples, different objects of the same type associated with an account may have different privacy settings. Different types of objects associated with an account may have different types of privacy settings. As an example, and not by way of limitation, a first account 102(1) may specify that the first account 102(1)'s status updates are public, but any images shared by the first account 102(1) are visible only to the first account 102(1)'s friends on the online social network. As another example and not by way of limitation, an account may specify different privacy settings for different types of entities, such as individual accounts, friends-of-friends, followers, account groups, or corporate entities. As another example and not by way of limitation, a first account 102(1) may specify a group of accounts that may view videos posted by the first account 102(1), while keeping the videos from being visible to the first account 102(1)'s employer. In particular examples, different privacy settings may be provided for different account groups or account demographics. As an example, and not by way of limitation, a first account 102(1) may specify that other account who attend the same university as the first account 102(1) may view the first account 102(1)'s pictures, but that other account who are family members of the first account 102(1) may not view those same pictures.

In particular examples, the social networking system 106 may provide one or more default privacy settings for each object of a particular object-type. A privacy setting for an object that is set to a default may be changed by an account associated with that object. As an example, and not by way of limitation, all images posted by a first account 102(1) may have a default privacy setting of being visible only to friends of the first account 102(1) and, for a particular image, the first account 102(1) may change the privacy setting for the image to be visible to friends and friends-of-friends.

In particular examples, privacy settings may allow a first account 102(1) to specify (e.g., by opting out, by not opting in) whether the social networking system 106 may receive, collect, log, or store particular objects or information associated with the account for any purpose. In particular examples, privacy settings may allow the first account 102(1) to specify whether particular applications or processes may access, store, or use particular objects or information associated with the account. The privacy settings may allow the first account 102(1) to opt in or opt out of having objects or information accessed, stored, or used by specific applications or processes. The social networking system 106 may access such information in order to provide a particular function or service to the first account 102(1), without the social networking system 106 having access to that information for any other purposes. Before accessing, storing, or using such objects or information, the social networking system 106 may prompt the account to provide privacy settings specifying which applications or processes, if any, may access, store, or use the object or information prior to allowing any such action. As an example, and not by way of limitation, a first account 102(1) may transmit a message to a second account via an application related to the online social network (e.g., a messaging app), and may specify privacy settings that such messages should not be stored by the social networking system 106.

In particular examples, an account may specify whether particular types of objects or information associated with the first account 102(1) may be accessed, stored, or used by the social networking system 106. As an example, and not by way of limitation, the first account 102(1) may specify that images sent by the first account 102(1) through the social networking system 106 may not be stored by the social networking system 106. As another example and not by way of limitation, a first account 102(1) may specify that messages sent from the first account 102(1) to a particular second account may not be stored by the social networking system 106. As yet another example and not by way of limitation, a first account 102(1) may specify that all objects sent via a particular application may be saved by the social networking system 106.

In particular examples, privacy settings may allow a first account 102(1) to specify whether particular objects or information associated with the first account 102(1) may be accessed from particular client systems or third-party systems. The privacy settings may allow the first account 102(1) to opt in or opt out of having objects or information accessed from a particular device (e.g., the phone book on an account's smart phone), from a particular application (e.g., a messaging app), or from a particular system (e.g., an email server). The social networking system 106 may provide default privacy settings with respect to each device, system, or application, and/or the first account 102(1) may be prompted to specify a particular privacy setting for each context. As an example, and not by way of limitation, the first account 102(1) may utilize a location-services feature of the social networking system 106 to provide recommendations for restaurants or other places in proximity to the account. The first account 102(1)'s default privacy settings may specify that the social networking system 106 may use location information provided from a client device of the first account 102(1) to provide the location-based services, but that the social networking system 106 may not store the location information of the first account 102(1) or provide it to any third-party system. The first account 102(1) may then update the privacy settings to allow location information to be used by a third-party image-sharing application in order to geo-tag photos.

Privacy Settings for Mood, Emotion, or Sentiment Information

In particular examples, privacy settings may allow an account to specify whether current, past, or projected mood, emotion, or sentiment information associated with the account may be determined, and whether particular applications or processes may access, store, or use such information. The privacy settings may allow accounts to opt in or opt out of having mood, emotion, or sentiment information accessed, stored, or used by specific applications or processes. The social networking system 106 may predict or determine a mood, emotion, or sentiment associated with an account based on, for example, inputs provided by the account and interactions with particular objects, such as pages or content viewed by the account, posts or other content uploaded by the account, and interactions with other content of the online social network. In particular examples, the social networking system 106 may use an account's previous activities and calculated moods, emotions, or sentiments to determine a present mood, emotion, or sentiment. An account who wishes to enable this functionality may indicate in their privacy settings that they opt into the social networking system 106 receiving the inputs necessary to determine the mood, emotion, or sentiment. As an example, and not by way of limitation, the social networking system 106 may determine that a default privacy setting is to not receive any information necessary for determining mood, emotion, or sentiment until there is an express indication from an account that the social networking system 106 may do so. By contrast, if an account does not opt in to the social networking system 106 receiving these inputs (or affirmatively opts out of the social networking system 106 receiving these inputs), the social networking system 106 may be prevented from receiving, collecting, logging, or storing these inputs or any information associated with these inputs. In particular examples, the social networking system 106 may use the predicted mood, emotion, or sentiment to provide recommendations or advertisements to the account. In particular examples, if an account desires to make use of this function for specific purposes or applications, additional privacy settings may be specified by the account to opt in to using the mood, emotion, or sentiment information for the specific purposes or applications. As an example, and not by way of limitation, the social networking system 106 may use the account's mood, emotion, or sentiment to provide newsfeed items, pages, friends, or advertisements to an account. The account may specify in their privacy settings that the social networking system 106 may determine the account's mood, emotion, or sentiment. The account may then be asked to provide additional privacy settings to indicate the purposes for which the account's mood, emotion, or sentiment may be used. The account may indicate that the social networking system 106 may use his or her mood, emotion, or sentiment to provide newsfeed content and recommend pages, but not for recommending friends or advertisements. The social networking system 106 may then only provide newsfeed content or pages based on account mood, emotion, or sentiment, and may not use that information for any other purpose, even if not expressly prohibited by the privacy settings.

Privacy Settings for Ephemeral Sharing

In particular examples, privacy settings may allow an account to engage in the ephemeral sharing of objects on the online social network. Ephemeral sharing refers to the sharing of objects (e.g., posts, photos) or information for a finite period of time. Access or denial of access to the objects or information may be specified by time or date. As an example, and not by way of limitation, an account may specify that a particular image uploaded by the account is visible to the account's friends for the next week, after which time the image may no longer be accessible to other accounts. As another example and not by way of limitation, a company may post content related to a product release ahead of the official launch and specify that the content may not be visible to other accounts until after the product launch.

In particular examples, for particular objects or information having privacy settings specifying that they are ephemeral, the social networking system 106 may be restricted in its access, storage, or use of the objects or information. The social networking system 106 may temporarily access, store, or use these particular objects or information in order to facilitate particular actions of an account associated with the objects or information, and may subsequently delete the objects or information, as specified by the respective privacy settings. As an example, and not by way of limitation, a first account 102(1) may transmit a message to a second account, and the social networking system 106 may temporarily store the message in a data store until the second account has viewed or downloaded the message, at which point the social networking system 106 may delete the message from the data store. As another example and not by way of limitation, continuing with the prior example, the message may be stored for a specified period of time (e.g., 2 weeks), after which point the social networking system 106 may delete the message from the data store.

Privacy Settings for Account-Authentication and Experience-Personalization Information

In particular examples, the social networking system 106 may have functionalities that may use, as inputs, personal or biometric information of a user associated with an account for user-authentication or experience-personalization purposes. An account may opt to make use of these functionalities to enhance their experience on the online social network. As an example, and not by way of limitation, an account may provide personal or biometric information to the social networking system 106. The account's privacy settings may specify that such information may be used only for particular processes, such as authentication, and further specify that such information may not be shared with any third-party system or used for other processes or applications associated with the social networking system 106. As another example and not by way of limitation, the social networking system 106 may provide a functionality for an account to provide voice-print recordings to the online social network. As an example, and not by way of limitation, if an account wishes to utilize this function of the online social network, the user associated with the account may provide a voice recording of his or her own voice to provide a status update on the online social network. The recording of the voice-input may be compared to a voice print of the user associated with the account to determine what words were spoken by the account. The account's privacy setting may specify that such voice recording may be used only for voice-input purposes (e.g., to authenticate the account, to send voice messages, to improve voice recognition in order to use voice-operated features of the online social network), and further specify that such voice recording may not be shared with any third-party system or used by other processes or applications associated with the social networking system 106. As another example and not by way of limitation, the social networking system 106 may provide a functionality for an account to provide a reference image (e.g., a facial profile, a retinal scan) to the online social network. The online social network may compare the reference image against a later-received image input (e.g., to authenticate the account, to tag the account in photos). The account's privacy setting may specify that such voice recording may be used only for a limited purpose (e.g., authentication, tagging the account in photos), and further specify that such voice recording may not be shared with any third-party system or used by other processes or applications associated with the social networking system 106.

Account-Initiated Changes to Privacy Settings

In particular examples, changes to privacy settings may take effect retroactively, affecting the visibility of objects and content shared prior to the change. As an example, and not by way of limitation, a first account 102(1) may share a first image and specify that the first image is to be public to all other accounts. At a later time, the first account 102(1) may specify that any images shared by the first account 102(1) should be made visible only to a group associated with the first account 102(1). The social networking system 106 may determine that this privacy setting also applies to the first image and make the first image visible only to the first account's 102(1) group. In particular examples, the change in privacy settings may take effect only going forward. Continuing the example above, if the first account 102(1) changes privacy settings and then shares a second image, the second image may be visible only to the first account's 102(1) group, but the first image may remain visible to all accounts. In particular examples, in response to an account action to change a privacy setting, the social networking system 106 may further prompt the account to indicate whether the account wants to apply the changes to the privacy setting retroactively. In particular examples, an account change to privacy settings may be a one-off change specific to one object. In particular examples, an account change to privacy may be a global change for all objects associated with the account.

In particular examples, the social networking system 106 may determine that a first account 102(1) may want to change one or more privacy settings in response to a trigger action associated with the first account 102(1). The trigger action may be any suitable action on the online social network. As an example, and not by way of limitation, a trigger action may be a change in the relationship between a first and second account of the online social network (e.g., “un-friending” an account, changing the relationship status between the accounts). In particular examples, upon determining that a trigger action has occurred, the social networking system 106 may prompt the first account 102(1) to change the privacy settings regarding the visibility of objects associated with the first account 102(1). The prompt may redirect the first account 102(1) to a workflow process for editing privacy settings with respect to one or more entities associated with the trigger action. The privacy settings associated with the first account 102(1) may be changed only in response to an explicit input from the first account 102(1) and may not be changed without the approval of the first account 102(1). As an example and not by way of limitation, the workflow process may include providing the first account 102(1) with the current privacy settings with respect to the second account or to a group of accounts (e.g., un-tagging the first account 102(1) or second account from particular objects, changing the visibility of particular objects with respect to the second account or group of accounts), and receiving an indication from the first account 102(1) to change the privacy settings based on any of the methods described herein, or to keep the existing privacy settings.

In particular examples, an account may need to provide verification of a privacy setting before allowing the account to perform particular actions on the online social network, or to provide verification before changing a particular privacy setting. When performing particular actions or changing a particular privacy setting, a prompt may be presented to the account to remind the account of his or her current privacy settings and to ask the account to verify the privacy settings with respect to the particular action. Furthermore, an account may need to provide confirmation, double-confirmation, authentication, or other suitable types of verification before proceeding with the particular action, and the action may not be complete until such verification is provided. As an example, and not by way of limitation, an account's default privacy settings may indicate that a person's relationship status is visible to all accounts (i.e., “public”). However, if the account changes his or her relationship status, the social networking system 106 may determine that such action may be sensitive and may prompt the account to confirm that his or her relationship status should remain public before proceeding. As another example and not by way of limitation, an account's privacy settings may specify that the account's posts are visible only to friends of the account. However, if the account changes the privacy setting for his or her posts to being public, the social networking system 106 may prompt the accounts with a reminder of the account's current privacy settings of posts being visible only to friends, and a warning that this change will make all of the account's past posts visible to the public. The account may then be required to provide a second verification, input authentication credentials, or provide other types of verification before proceeding with the change in privacy settings. In particular examples, an account may need to provide verification of a privacy setting on a periodic basis. A prompt or reminder may be periodically sent to the account based either on time elapsed or a number of account actions. As an example, and not by way of limitation, the social networking system 106 may send a reminder to the account to confirm his or her privacy settings every six months or after every ten photo posts. In particular examples, privacy settings may also allow accounts to control access to the objects or information on a per-request basis. As an example, and not by way of limitation, the social networking system 106 may notify the account whenever a third-party system attempts to access information associated with the account and require the account to provide verification that access should be allowed before proceeding.

### EXAMPLE USER INTERFACES

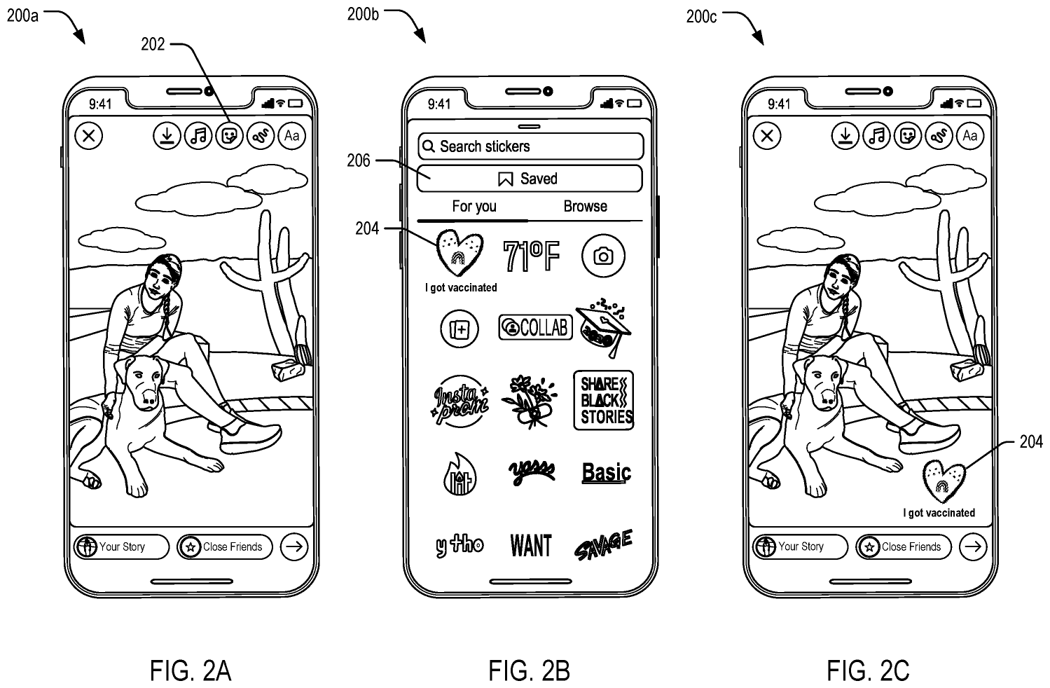

FIG. 2A-FIG. 11 are schematic views showing example user interfaces that are usable to implement the techniques described herein for customizing, sharing, and populating stickers across multiple social media platforms. The interfaces and/or the notifications may be generated by a computing device of a social networking system (e.g., social networking system 106) and transmitted to one or more user computing devices (e.g., computing devices 104) for presentation, and/or the interfaces may be generated by the one or more user computing devices based at least in part on instructions received from the social networking system 106. As discussed above, the interfaces described in this section may, but need not, be implemented in the context of the computing system 100.

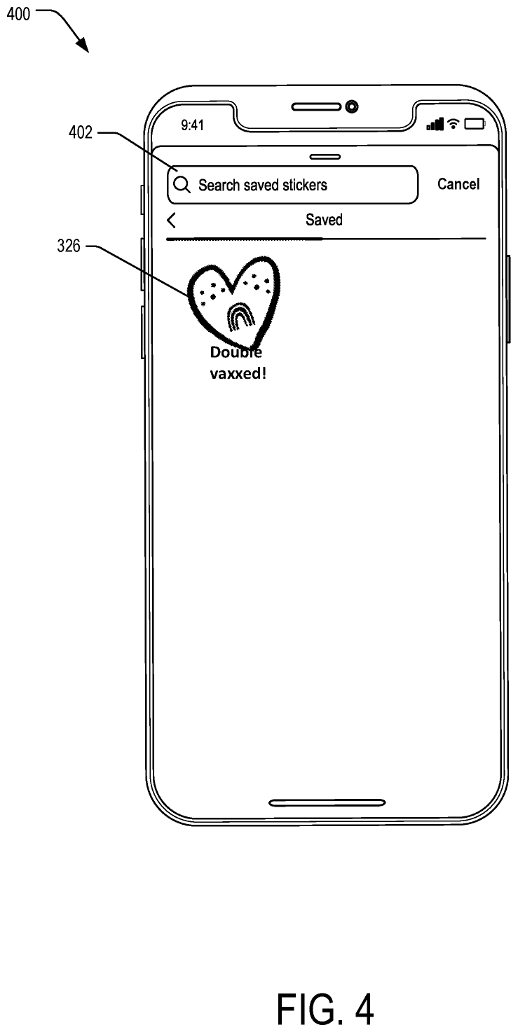

FIGS. 2A-2C illustrate example interfaces for adding a sticker to a content item. For example, as shown in FIG. 2A, the first account 102(1) may create a content item, as depicted by user interface 200a. For example, the first account 102(1) may upload a photo to share via the social networking system 106 as an ephemeral content item, such as a story. Though illustrated as an image and text, this is not intended to be so limiting, and the content item may additionally or alternatively include videos, audio, and/or posts by other accounts 102, to name a few non-limiting examples. In some examples, the user interface 200a may include options to edit the content item, such as a “sticker” selectable control 202. Upon selection of the sticker selectable control 202, the first account 102(1) may access a “sticker tray” interface 200b, which may include one or more selectable stickers, such as sticker 204, which the first account 102(1) may add to the content item. The sticker tray interface 200b may additionally include a “saved sticker” selectable control 206, which is described below in FIG. 4. In some examples, in response to a selection of the sticker 204, the social networking system 106 may add the sticker 204 to the content item, as depicted by user interface 200c.

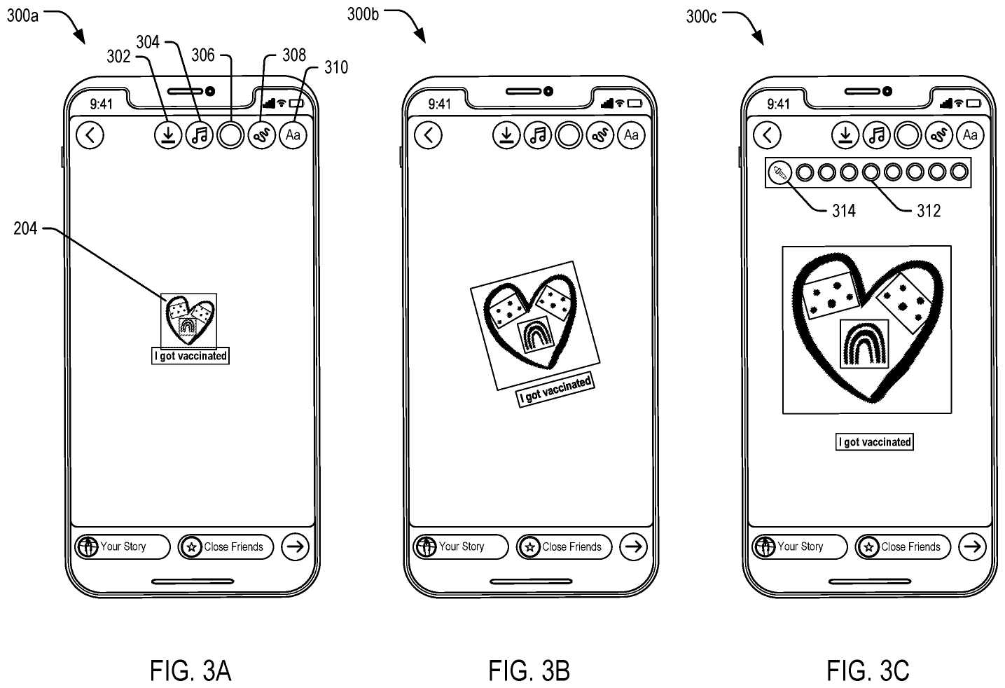

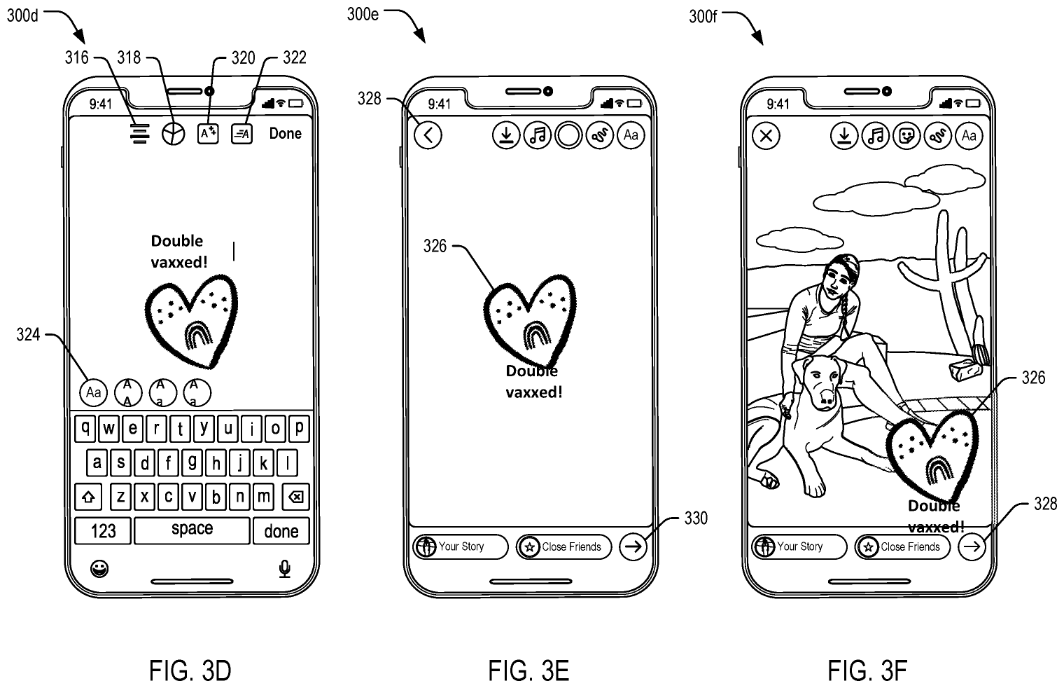

FIGS. 3A-3F illustrate example user interfaces for creating a modified sticker in a sticker interface, such as sticker interface 300a. For example, in response to a selection of the sticker 204, the social networking system 106 may present, to the first account 102(1), the sticker. In some examples, one or more elements of the sticker may be highlighted for ease of modification. For example, an element may include one or more shapes, text boxes, or images. Thus, as one example, individual ones of the one or more elements may contain an outline around the individual elements, allowing the user associated with the first account 102(1) to easily visualize and select the element to be modified.

In some examples, the sticker interface 300a may include one or more selectable controls for modifying the sticker. For example, the sticker interface 300a may include a “save” selectable control 302 which, upon selection, may allow the first account 102(1) to save the sticker, including any modifications, to a sticker library. The sticker library is described in more detail in FIG. 4, below. Additionally or alternatively, the save selectable control 302 may, in response to a selection by the first account 102)1), allow the first account 102(1) to save an image of the sticker to a camera roll of the computing device 104(1).

In some examples, the sticker interface 300a may include an “audio” selectable control 304, which, in response to a selection by the first account 102(1), may cause the social networking system 106 to present, to the first account 102(1), a separate audio interface. The audio interface (not pictured) may include one or more options to add one or more audio components to the sticker, such as a song, a sound effect, and/or an audio recording, to name a few nonlimiting examples. Additionally or alternatively, the sticker interface may include a “color” selectable control 306 which, in response to a selection by the first account 102(1), may allow the first account 102(1) to modify a color of an element of the sticker. The sticker interface 300a may further include a “draw” selectable control 308 which may allow a user associated with the first account 102(1) to manually draw on the sticker, and a “text” selectable control 310 which may allow the first account 102(1) to modify text associated with the sticker.

In some examples, the first account 102(1) may modify a size, a shape, and/or an orientation of an element of a sticker. For example, as illustrated in sticker interface 300b, the first account 102(1) has both rotated and increased the size of the sicker 204. Other modifications, although not depicted in interface 300b, may include, but are not limited to, decreasing the size of one or more elements, re-positioning the one or more elements, and rotating the one or more elements. In some examples, a user associated with the first account 102(1) may modify the size, shape, and/or orientation of the one or more elements manually, such as via a touch input.

FIG. 3C illustrates an example sticker interface 300c for editing a color of the one or more elements of the sticker. For example, in response to a selection of the “color” selectable control 306, the social networking system 106 may present, to the first account 102(1), user interface 300c. The user interface 300c may include one or more color swatch selectable controls, such as “color swatch” selectable control 312. Although not depicted, the one or more color swatch selectable controls may include one or more colors that may correspond to a color of an element that the sticker may be modified to. The user interface 300c may also include an “eyedropper” selectable control 314 that, when selected, may enable the first account 102(1) to select a color from a pre-exiting element of the sticker.

In other examples, the first account 102(1) may modify text associated with the sticker. For example, upon selection of the “text” selectable control 310, the first account 102(1) may be presented user interface 300d. The user interface 300d may include one more selectable controls associated with a modification of text, such as a “text alignment” selectable control 316, a “text color” selectable control 318, a “text highlight” selectable control 320, and a “text animation” selectable control 322, which may enable the first account 102(2) to modify an alignment of text, modify a color of text, highlight text, and animate text, respectfully. Additionally or alternatively, the first account 102(1) may modify a type of font associated with text. For example, in response to a selection of a text element by the first account 102(1), the social networking system 106 may display various text options, such as “text option 1” control 324, that, upon selection, may change the font of the text. As illustrated in user interface 300d, the first account 102(1) has both changed the content of the text “I got vaccinated” to “Double vaxxed!” and a style of the font.

User interface 300e illustrates a modified sticker 326. For example, the modified sticker 326 may be version of the sticker 204, including one or more modifications applied by the first account 102(1), such as by using the features described in FIGS. 3A-3D. In the current illustration, the first account 102(1) has modified both a size and an orientation of multiple elements of the sticker, a content of the font, and a type of the font. In some examples, the user interface 300e may include a “back” selectable control 328 and a “send” selectable control 330. For example, in response to a selection of the back selectable control 328, the first account 102(1) may be presented user interface 300f, which may include the modified sticker 326. Similar to user interface 200a, the user interface 300f may include the content item. However, rather than the sticker 204, the content item as depicted in user interface 300f may include the modified sticker 326.

FIG. 4 illustrates an example user interface 400 usable to access and modify saved stickers. For example, in response to selection of the saved sticker selectable control 206, illustrated in FIG. 2A, the social networking system 106 may present, to the first account 102(1), a saved sticker user interface, such as user interface 400. The saved sticker user interface may include one or more saved stickers, which may include one or more stickers modified by the first account 102(1), such as modified sticker 326. In some examples, the user interface 400 may include a “search” selectable control 602, which may enable the first account 102(1) to search for saved stickers.

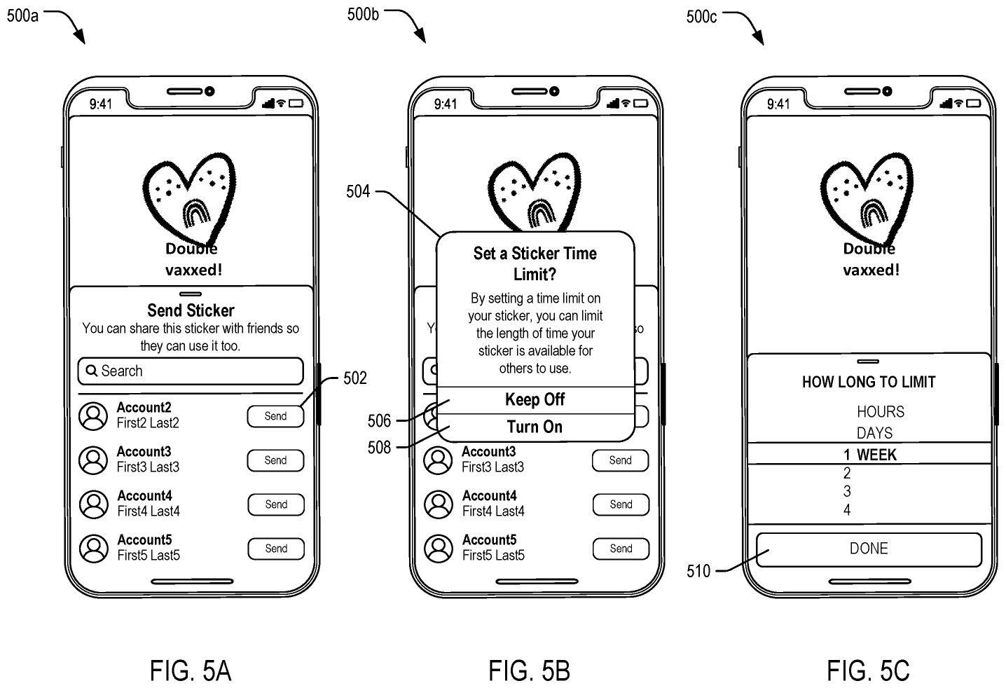

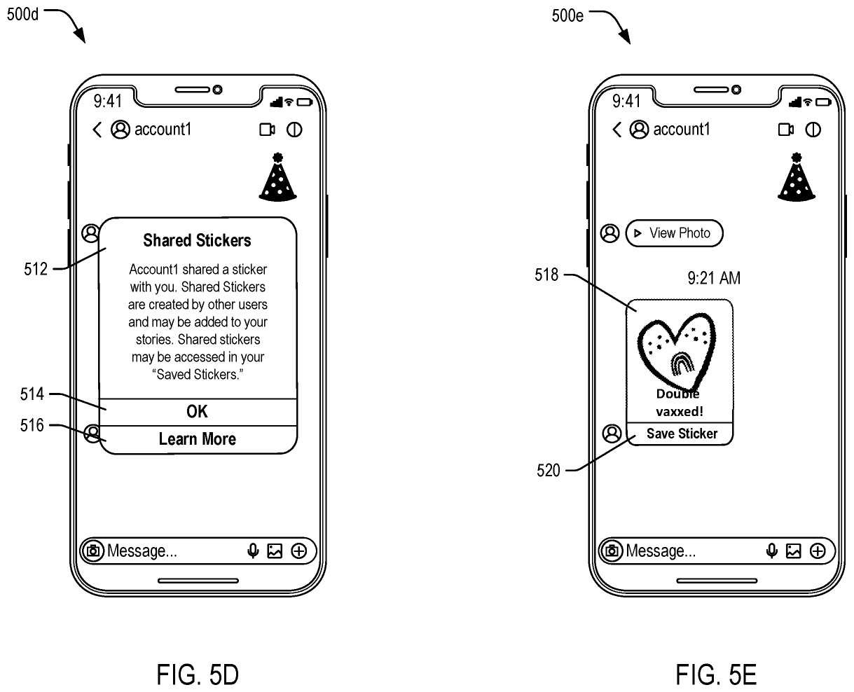

FIGS. 5A-5E illustrate example user interfaces usable for sharing modified stickers with other accounts of the social networking system. For example, in response to a selection of the send selectable control 330 by the first account 102(1), as illustrated in FIG. 3E, the social networking system 106 may present user interface 500a. For example, user interface 500a may include one or more options to share the modified sticker, such as to a second account 102(2) of the social networking system. In some examples, upon selection of a send selectable control 502 by the first account 102(1), the social networking system 106 may present a notification 504 to the first account 102(1) prompting the first account 102(1) to determine a time limit associated with the modified sticker. The notification 504 may, in some examples, include selectable controls 506 and/or 508. For example, selection of the control 506 may enable the first account 102(1) to share the modified sticker without a time limit, thus allowing the modified stickers sent to other accounts to be available for those other accounts to use indefinitely. Conversely, selection of control 508 may enable the first account 102(1) to associate a time limit with the modified sticker, allowing the first account 102(1) to limit an amount of time the modified sticker is available for other accounts to use.

In response to a selection of the control 508, the social networking system 106 may present, to the first account 102(1), user interface 500c. For example, the first account 102(1) may be presented a selectable control 510 in which the first account 102(1) may determine a period of time to limit the availability of the shared sticker (e.g., one day, five days, one week, two weeks, etc.). In some examples, the first account 102(1) may set one or more time limits for specific accounts. For example, the first account 102(1) may select a first time limit for a second account and select a second time limit for a third account, the second time limit being different than the third limit. In this way, the first account 102(1) may control how and how long the modified sticker is used. Additionally, in some examples and although not pictured, the first account 102(1) may set a reminder when the period of time to limit the availability of the shared sticker has expired, allowing the first account 102(1) extend the time limit.

In some examples, as illustrated by user interfaces 500d and 500e in FIGS. 5D and 5E, respectfully, the social networking system 106 may send a notification 512 to a second account 102(2) as a direct message to an inbox of the second account 102(2). For example, the notification 512 may include an “OK” selectable icon 514 in which, in response to a selection by the second account 102(2), may cause the social networking system 106 to remove the notification 512 and cause presentation of user interface 500e. Additionally, the notification 512 may include a “learn more” selectable control 516 which, in response to a selection by the second account 102(2), may cause the social networking system 106 to provide, to the second account 102(2), additional information regarding shared stickers.

FIG. 5E illustrates example user interface 500e usable for the second account 102(2) to save the shared modified sticker via a direct message 518. For example, the direct message sent to the second account 102(2) may include a “save sticker” selectable control 520 which, in response to a selection by the second account 102(2), may cause the shared modified sticker to be added to a saved sticker library of the second account, similar to that described in FIG. 4.

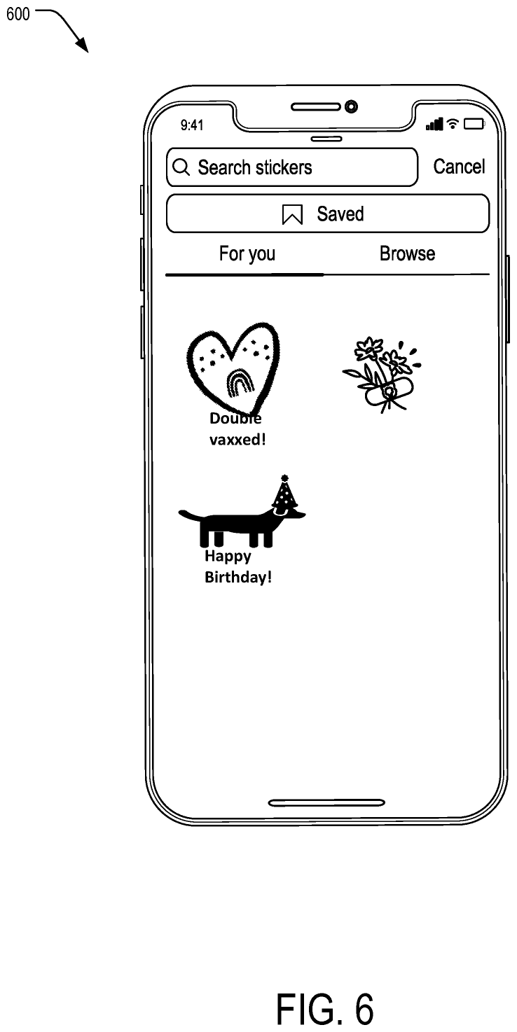

In some examples, the social networking system 106 may recommend stickers to the first account 102(1). FIG. 6 illustrates example interface 600 usable for accessing recommended stickers. For example, user interface 600 may be the same or similar to user interface 400 illustrated in FIG. 4. For example, the social networking system 106 may recommend stickers, herein referred to as “preferred stickers,” to the first account 102(1) based at least in part on implicit and/or explicit signals from the first account 102(1). In some examples, the social networking system 106 may store the one or more modifications as a preference of the first account 102(1). The modifications can be based on explicit user input and/or can be performed automatically based on implicit input or signals previously received based on the user's interaction with the account (e.g., preferences, settings, demographic information, usage information, social network connections, search history, content sharing history, comment history, etc.). The social networking system 106 may then generate, based at least in part on the one or more modifications, one or more preferred stickers. The social networking system 106 may, in some examples, store the one or more preferred stickers in the sticker tray. Similar to the first sticker, the one or more preferred stickers may be added to a content item to be shared with a second account 102(2).

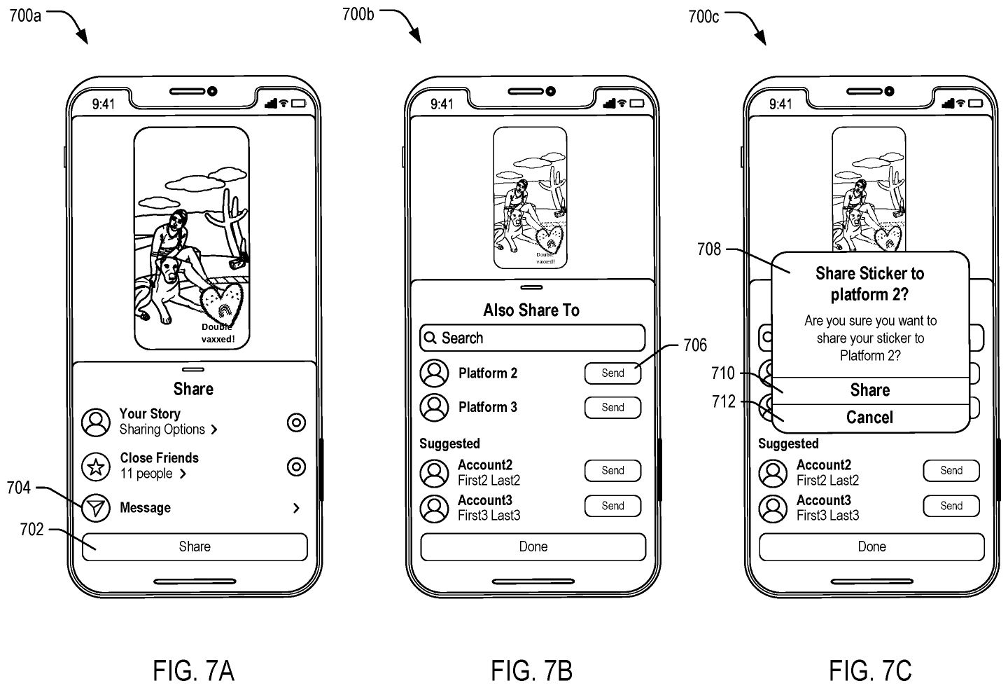

FIG. 7A-7C illustrates example user interfaces usable for the first account 102(1) to share a modified sticker from a first platform to a second platform as a second sticker. For example, in response to selection of the send selectable icon 328 depicted in FIG. 3F, the social networking system 106 may present, to the first account 102(1), user interface 700a. The user interface 700a may include one or more selectable controls, such as a “share” selectable control 702, which may enable the first account 102(1) to share the content item and/or modified sticker. For example, as illustrated in FIG. 7A, the first account 102(1) has selected to share the content item, including the modified sticker, as a both story and to the close friends of the first account 102(1). Additionally or alternatively, the user interface 700a may include a “message” selectable icon 704, which, in response to a selection by the first account 102(1), may provide the first account 102(1) with one or more additional options with which to share the content item and/or modified sticker.

In response to a selection of the message selectable icon 704, the social networking system 106 may present, to the first account 102(1), user interface 700b usable for selecting a second platform to share the modified sticker as a second sticker. In some examples, the second platform may be different than the first platform. For example, the second platform may be an application provided by the same social networking system as the first platform, such as social networking system 106. However, in other examples, the first platform and the second platform may be unrelated. For example, the first platform may be associated with separate social networking systems and/or separate third-party applications.

For example, user interface 700b may include a “send” selectable icon 706 which, in response to a selection by the first account 102(1), may cause the social networking system 106 to share the modified sticker to a second platform. It may be noted, however, that although the current illustration depicts sharing the modified sticker, any sticker and/or content item may be shared to the second platform, including stickers that have not been modified. In some examples, in response to a selection of the send selectable icon 706 by the first account 102(1), the social networking system 106 may present, to the first account 102(1), a notification 708, depicted in user interface 700c, prompting the first account 102(1) to confirm a decision to share the modified sticker to the second platform. The notification 708 may, in some examples, include selectable controls 710 and/or 712. For example, selection of the “share” control 710 may cause the social networking system 106 to share the modified sticker to the second platform. Conversely, selection of the “cancel” control 712 may prevent the social networking system 106 from sharing the modified sticker to the second platform.

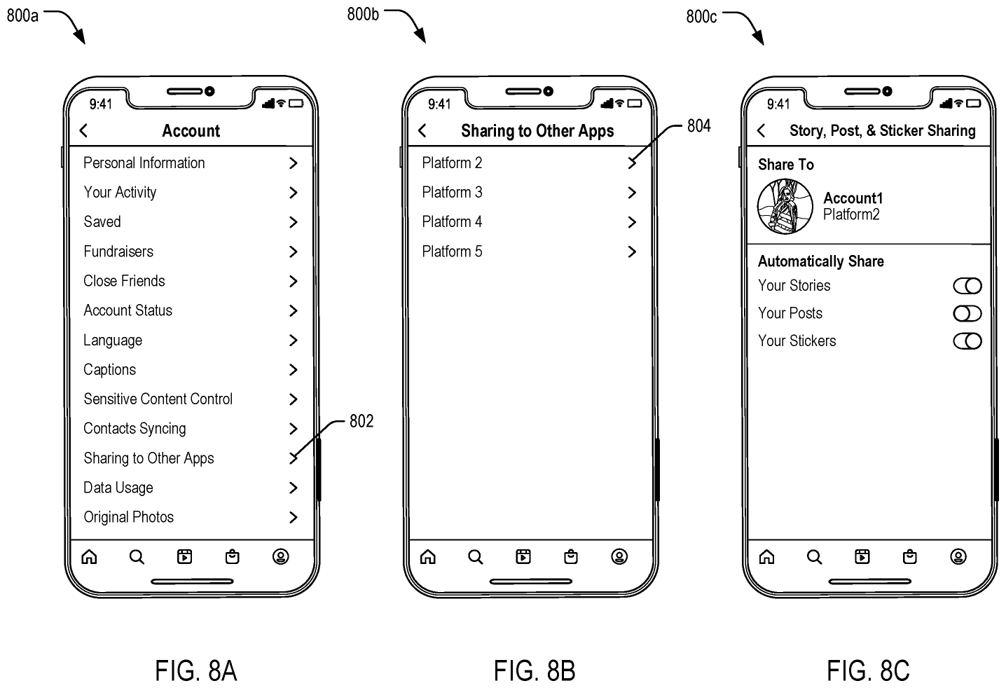

FIGS. 8A-8C illustrate example user interfaces usable for enabling sharing of a modified sticker to a second platform as a second sticker. Similar to that described with respect to FIGS. 7A-7C, although the current illustration describes sharing a modified sticker, any sticker and/or content item may be shared. For example, as shown in FIG. 8A, the first account 102(1) may access an account setting interface, as depicted by user interface 800a. The user interface 800a may, in some examples, include a “Sharing to Other Apps” selectable control 802. In response to a selection of the Sharing to Other Apps selectable control 802, the social networking system 106 may present, to the first account 102(1), a “Sharing to Other Apps” user interface 800b, which may include selectable controls which may allow the first account 102(1) to determine one or more platforms to share content to.

For example, the Sharing to Other Apps user interface 800b may include a “Platform 2” selectable control 804 which may enable the first account 102(1) to customize content sharing preferences for a second platform, Platform 2. In response to a selection of the Platform 2 selectable control 804, the social networking system 106 may present, to the first account 102(1), Platform 2 settings user interface 800c. Platform 2 settings user interface 800c may, in some examples, include one or more selectable controls which may allow the first account 102(1) to customize an ability to share content items, such as stories, posts, and stickers, across multiple platforms. As depicted in the Other Apps user interface 800b for platform 2 settings, selectable controls for automatically sharing stories and stickers to platform 2 are turned on, while, a selectable control associated with automatically sharing posts is turned off.

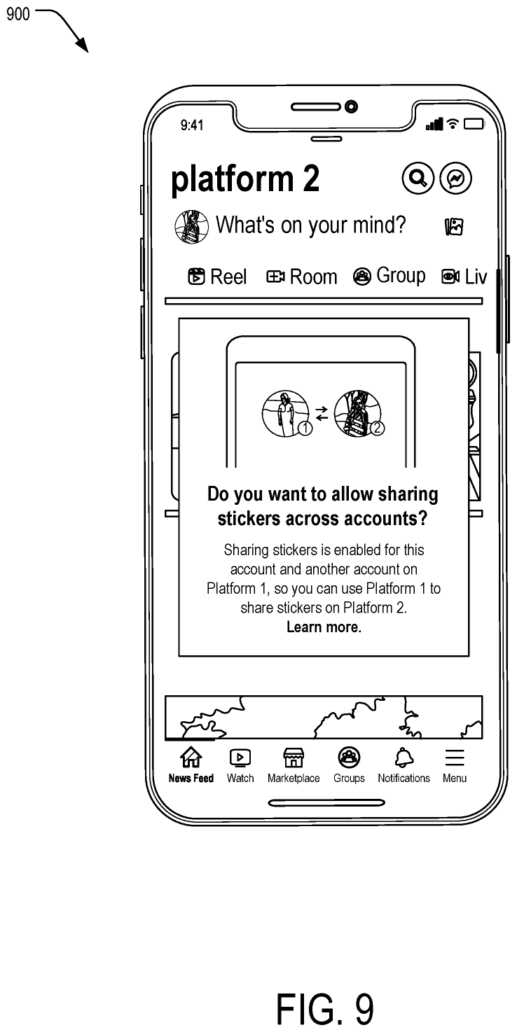

FIG. 9 illustrates an example user interface 900 usable for confirmation of sharing a modified sticker to a second platform as a second sticker. For example, in response to receiving an indication to share the modified sticker to the second platform by the first account 102(1) and upon opening the second platform, the social networking system 106 may present, to the first account 102(1), a notification 902. Although illustrated as accessed by the first account 102(1), this is not intended to be so limiting, and any account may access the second platform. In some examples, although not pictured, the notification 902 may include one or more selectable controls to confirm sharing the modified sticker (referred to in this section as “a second sticker”) to the second platform and/or to remove the second sticker from the second platform.

FIGS. 10A-10C illustrate example user interfaces usable for modifying a second sticker on a second platform. In some examples, the first account 102(1) may access a profile user interface 1000a of the second platform. However, similar to that described above with respect to FIG. 9, any account may access the second platform. The profile user interface 1000a may include an “edit profile” selectable icon 1002 which, in response to a selection by the first account 102(1), may cause the social networking system 106 to present user interface 1000b. User interface 1000b may, in some examples, include an “add sticker” selectable icon 1004 which may enable the first account 102(1) to modify, add, and/or remove the second sticker. For example, in response to a selection of the add sticker icon 1004, the social networking system 106 may cause presentation of profile sticker user interface 1000c usable for modifying the second sticker. The profile sticker user interface 1000c may, in some examples, include one or more customizations to apply to the second sticker, such as customizations 1006a, 1006b, 1006c, and 1006d. Additionally, in some examples and not illustrated, the second platform may include an interface usable for modifying the second sticker, similar to the sticker interface 300a.

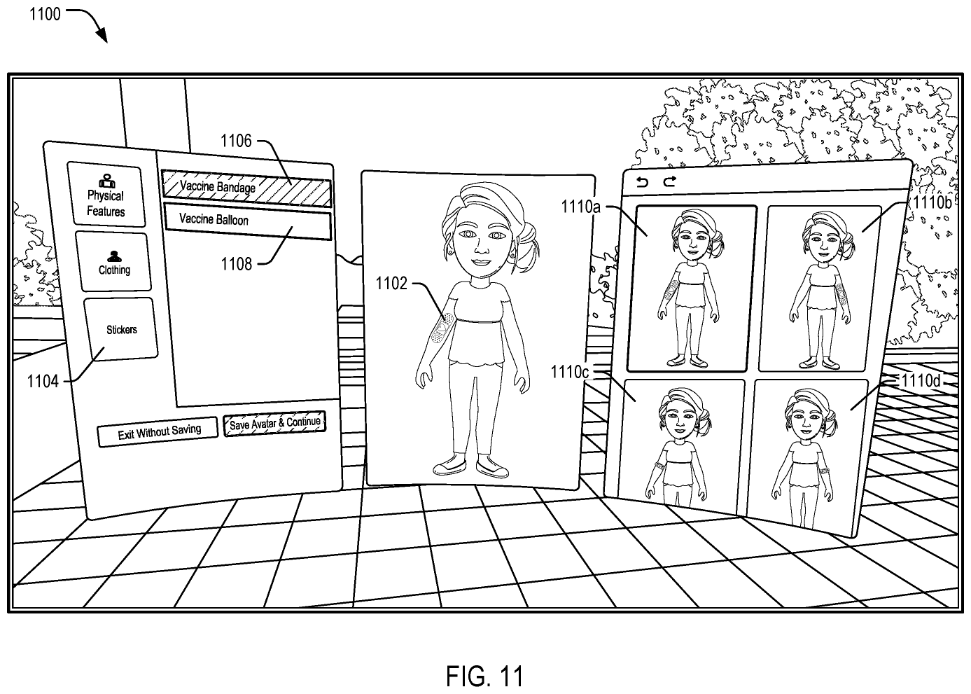

In some examples, the first account 102(1) may apply a third sticker to a third platform different than the first platform and the second platform. FIG. 11 illustrates an example user interface 1100 illustrating a third sticker 1102 applied in a third platform. For example, similar to applying the modified sticker to the second platform as a second sticker, the first account 102(1) may apply the modified sticker and/or the first sticker from the first platform and/or the second platform to the third platform. Similar to the second platform, the third platform may be different than the first platform. For example, the third platform may be an application provided by the same social networking system as the first platform, such as social networking system 106. However, in other examples, the first platform and the third platform may be unrelated. For example, the first platform and the third platform may be associated with separate social networking systems and/or separate third-party applications. As illustrated in FIG. 11, the third platform may include an extended reality environment, such as virtual reality, mixed reality, augmented reality, or other computer-generated environments. Extended reality elements refer to two- or three-dimensional computer-generated images or objects that are presented in, overlaid on, or otherwise associated with an extended reality environment. Users can access an extended reality environment using a computing device, such as a wearable device (e.g., a headset, glasses, watch, etc.), a computer, a mobile device (e.g., phone or tablet), a gaming device, or various other computing devices. The computing device used to access the extended reality environment can be implemented as a standalone computing device comprising substantially all functionality in a single device, or can be coupled via wired or wireless connection to one or more other computing devices (e.g., PCs, servers, gateway devices, coprocessors, etc.), peripheral devices, and/or input/output devices.

In some examples, the third sticker may appear visually different than the first sticker and/or the second sticker but may still correspond to the first sticker and/or the second sticker. For example, the first sticker is a static image, including the text “I got vaccinated.” However, the third sticker 1102 appears as a bandage on an avatar of the first account 102(1), thus indicating that the first account 102(1) recently received a vaccination.

In some examples, the first account 102(1) or second account 102(2) may modify the third sticker 1102. For example, similar to the second platform, the third platform may include a “stickers” selectable control 1104 which, in response to a selection by the first account 102(1) or the second account 102(2), may cause the social networking system 106 to present one or more options to modify the third sticker, such as “Vaccine Bandage” selectable control 1106 and “Vaccine Balloon” selectable control 1108. In the current example, the first account 102(1) has selected the vaccine bandage selectable control 1106, as depicted by the avatar of the first account 102(1) wearing a bandage on the avatar's right arm. In some examples, in response to a selection of an option to modify the third sticker, the social networking system 106 may provide, to the first account 102(1) or the second account 102(2), various options to further customize the modifications. For example, as depicted by selectable options 1110a, 1110b, 1110c, and 1110d, the social networking system 106 may provide the first account 102(1) or the second account 102(2) places in which the third sticker may be placed relative to the avatar of the first account 102(1). For example, selectable option depicts the bandage located on the avatar of the first account 102(1) on various locations such as the left shoulder, the right shoulder, the left forearm, and the right forearm. In this way, the first account 102(1) or the second account 102(2) is afforded greater freedom and flexibility in creative expression.

### EXAMPLE METHODS

Various methods are described with reference to the example system of FIG. 1 for convenience and ease of understanding. However, the methods described are not limited to being performed using the system of FIG. 1 and may be implemented using systems and devices other than those described herein.

The methods described herein represent sequences of operations that can be implemented in hardware, software, or a combination thereof. In the context of software, the blocks represent computer-executable instructions stored on one or more computer-readable storage media that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described operations can be combined in any order and/or in parallel to implement the processes. In some examples, one or more operations of the method may be omitted entirely. Moreover, the methods described herein can be combined in whole or in part with each other or with other methods.

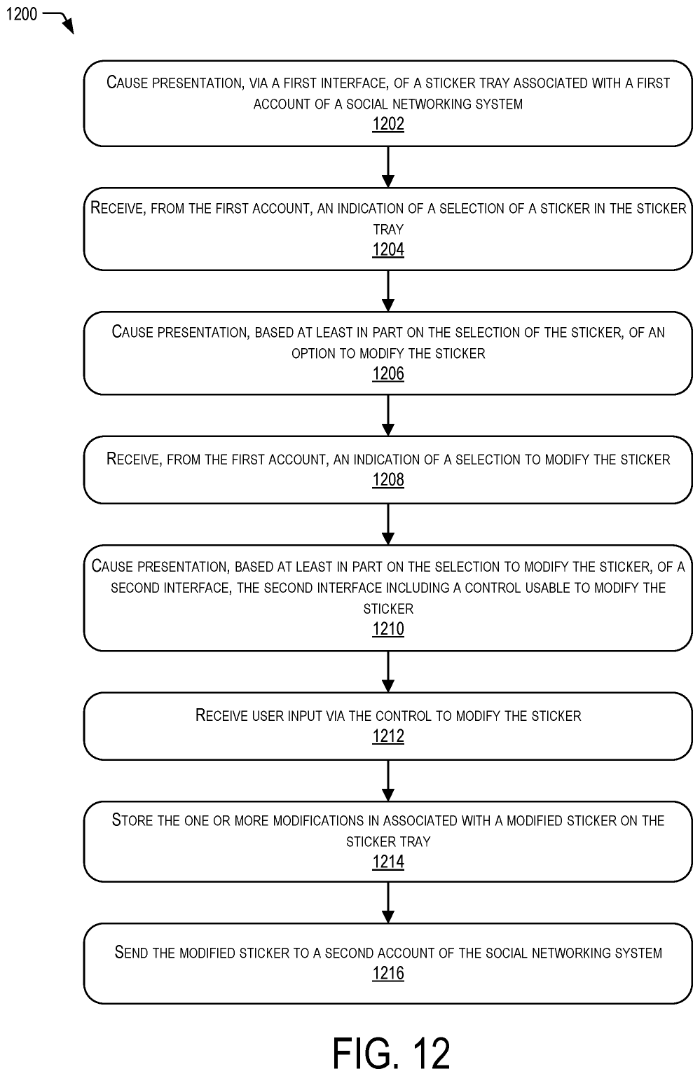

FIG. 12 depicts an example process 1200 for modifying a sticker. For example, at operation 1202, the process may include causing presentation, via a first interface, of a sticker tray associated with a first account of a social networking system. A sticker may include a graphic design element which may be added to a content item of the social networking system to increase aesthetic appeal and/or foster engagement with other accounts. Stickers may be accessible via one or more platforms associated with the social networking system and may be available for accounts of the social networking system to use.

At operation 1204, the process may include receiving, from the first account, an indication of a selection of a sticker in the sticker tray. The one or more stickers, for example, may be generated by the social networking system. Additionally or alternatively, the one or more stickers may be generated by accounts of the social networking system, other social networking applications, and/or third-party applications.

At operation 1206, the process may include causing presentation, based at least in part on the selection of the sticker, of an option to modify the sticker.

At operation 1208, the process may include receiving, from the first account, an indication of a selection to modify the sticker. Modifications may include any change to one or more elements of the sticker. For example, a sticker may have multiple elements, such as one or more shapes, texts, or images. Thus, a modification to an element may include a change to a font (e.g., a change in a font type, a font color, a font size, a text of a font, an alignment of a text, etc.), a change to a shape (e.g., a change in a shape size, a shape color, a shape outline, etc.), or a change to an image (e.g., an image type, an image filter, an image size, an image opacity, an, etc.). Modifications may also include a change to a relationship between elements, such as bringing an element to a foreground or moving an element to a background or animating an element.

At operation 1210, the process may include causing presentation, based at least in part on the selection to modify the sticker, of a second interface including a control usable to modify the sticker. For example, the second interface may include one or more options that, when selected, may allow the account to make one or more modifications to the sticker.

At operation 1212, the process may include receiving user input via the control to modify the sticker.

At operation 1214, the process may include storing the one or more modifications in association with a modified sticker on the sticker tray. In some examples, the modified sticker may be available for the account to add to one or more content items and/or share to other accounts.

At operation 1216, the process may include sending the modified sticker to a second account of the social networking system. For example, the first account may receive an indication to share the modified sticker with a second account. Based at least in part on receiving, from the first account, an indication to share the modified sticker, the social networking system may send the modified sticker to the second account. In some examples, in response to sending the modified sticker to the second account, the social networking system may add the modified sticker to a sticker tray of the second account, allowing the second account to use, share, and/or further modify the modified sticker.

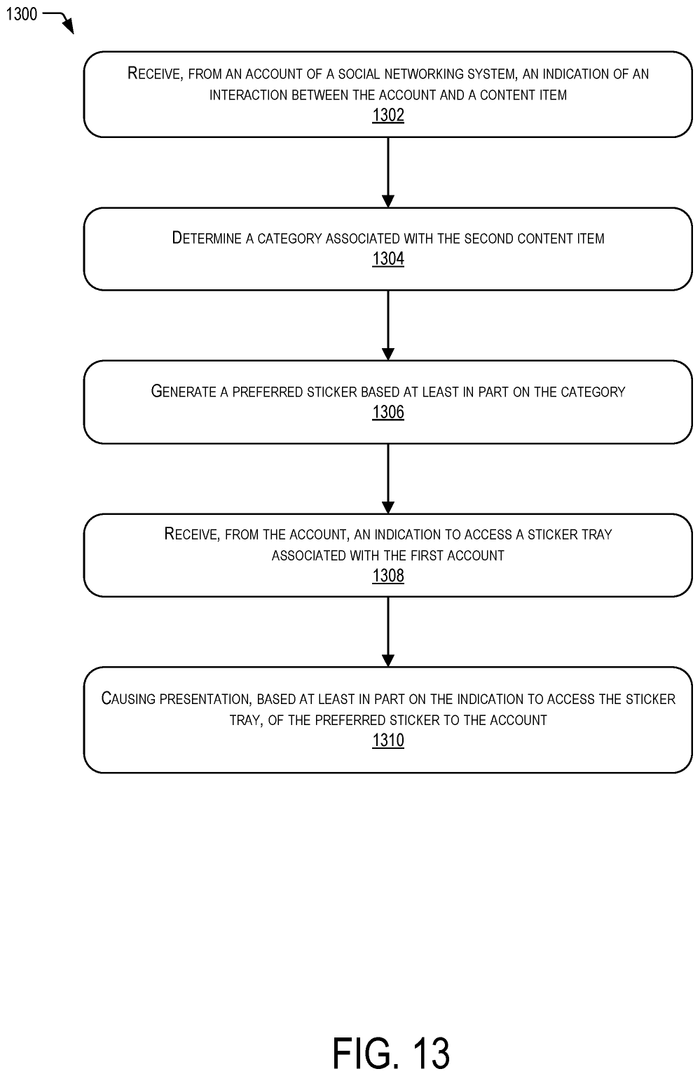

FIG. 13 illustrates an example process for generating preferred stickers based at least in part on implicit signals. An implicit signal may be a signal derived or inferred from an action performed by the first account such as liking or commenting on a post.

At operation 1302, the process may include receiving, from an account of a social networking system, an indication of an interaction between the account and a content item. The interaction may include an implicit signal by the account such as liking a post, commenting on a post, sharing a post, saving a post, sending a message, searching for a category, enabling notifications on a post, to name a few non-limiting examples.

At operation 1304, the process may include determining a category associated with the second content item. The category may be broad (e.g., animals, food, athletics, etc.) and/or may be more specific (e.g., black labs, French cuisine, triathlon, etc.).

At operation 1306, the process may include generating a preferred sticker based at least in part on the category. For example, the preferred sticker may be associated with the category, such as including a graphic or text element associated with the category.

At operation 1308, the process may include receiving, from the account, an indication to access a sticker tray associated with the account. The sticker tray may include, for example, one or more stickers which may be added to content items.

At operation 1310, the process may include causing presentation, based at least in part on the indication to access the sticker tray, of the preferred sticker to the account. In this way, the social networking system may ensure that the sticker is likely to be of interest to the account, prompting the account to apply the preferred sticker to content items.

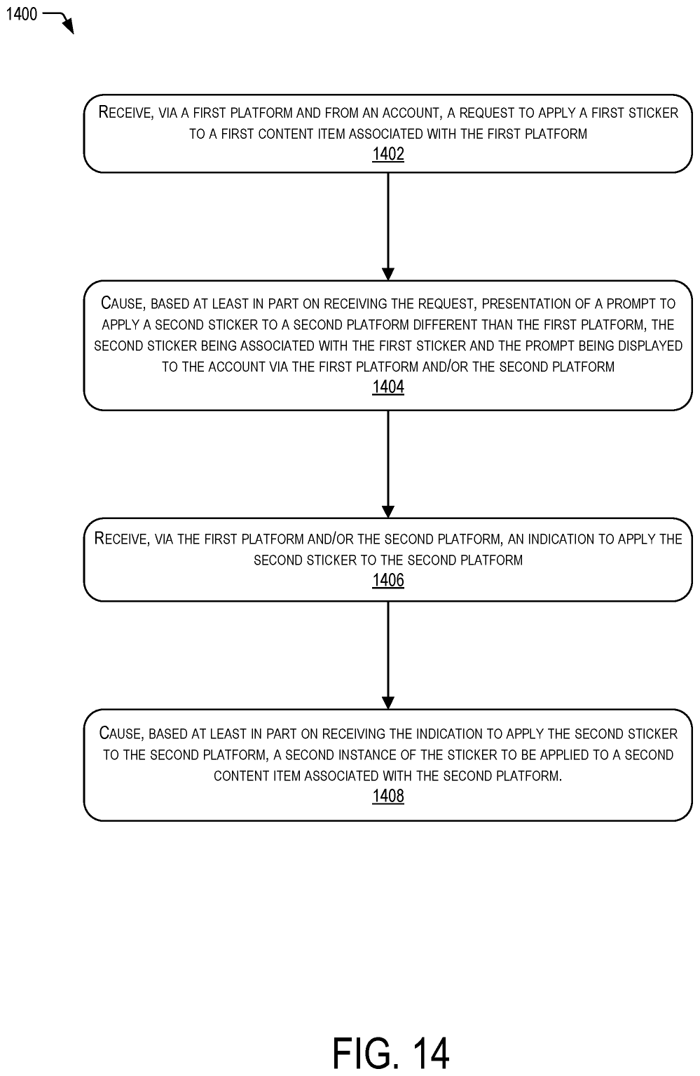

FIG. 14 illustrates an example process 1400 for sharing a first sticker on a first platform as a second sticker on a second platform. For example, at operation 1302, the process may include receiving, via a first platform and from an account, a request to apply a first sticker to a first content item associated with the first platform.

At operation 1404, the process may include causing, based at least in part on receiving the request, presentation of a prompt to apply a second sticker to a second platform different that the first platform, the second sticker being associated with the first sticker and the prompt being displayed to the account via the first platform and/or the second platform. For example, the second platform may be administered by a same entity as the first platform (e.g., two different products offered by the same company), related entities (e.g., products offered by subsidiaries or affiliated companies), or by separate/unrelated entities. The second platform 116 may be of a same type as the first platform (e.g., both the first platform and the second platform are social networking platforms) or different types (e.g., a social networking platform and a gaming platform, or a video conferencing platform and a social networking platform, etc.).

In some examples, the first platform may send to the second platform data indicating that that the first sticker has been applied to the first content item. For example, this may occur automatically, such as absent additional input from a user associated with the account. Alternatively, the user associated with the account may link an account on the first platform to an account on the second platform. Based at least in part on receiving an indication that the account has logged on to or accessed the second platform, the second platform may provide, to the account, one or more options to apply the sticker to the second platform and/or a similar sticker.

At operation 1406, the process may include receiving, via the first platform and/or the second platform, and from the account, an indication to apply the second sticker to the second platform.

At operation 1408, the process may include causing, based at least in part on receiving the indication to apply the second sticker to the second platform, a second instance of the sticker to be applied to a second content item associated with the second platform. In some examples, the second sticker may be associated with the first sticker. For example, the first sticker and the second sticker may relate to a same concept or theme. In other examples, the first sticker and the second sticker may be platform specific instances of a same source sticker. Additionally or alternatively, the first sticker and the second sticker may be linked to a same source data structured maintained by at least one of the first platform, the second platform, or a third platform.

### EXAMPLE SYSTEM AND DEVICE

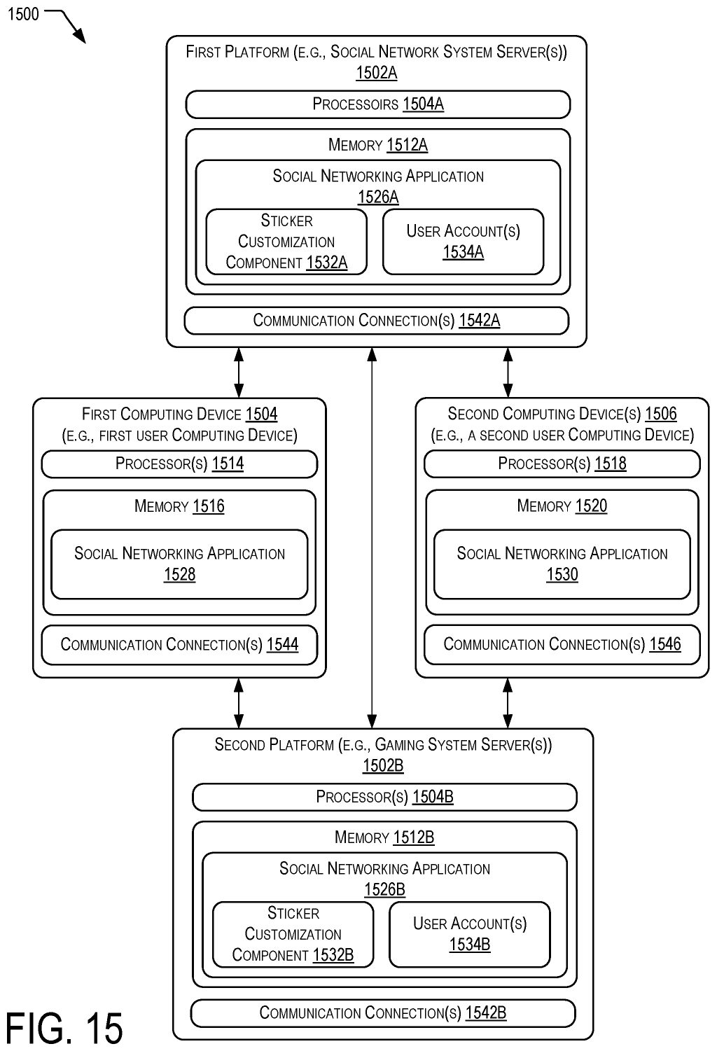

FIG. 15 illustrates a block diagram illustrating an example system 1500 of computing devices usable to implement example techniques described herein. For example, FIG. 15 illustrates example computing devices, including first platform 1502a and second platform 1502b, which may respectfully include one or more social network system servers and one or more gaming system servers, a first computing device 1504, and a second computing device 1506, that interact over a network, such as network 108 illustrated in FIG. 1. By way of example and not limitation, the first platform 1502a and/or the second platform 1502b may be representative of servers used to implement the system 100, the first computing device 1504 may be representative of the first user computing device 104(1) associated with the first user 102(1), and the second computing device 1506 may be representative of the second user computing device associated with a second user.

The first platform 1502a and/or the second platform 1502b may comprise one or more individual servers or other computing devices that may be physically located in a single central collection or may be distributed at multiple different locations. The servers associated with the first platform 1502a and/or the second platform 1502b may be hosted privately by an entity administering all or part of the communications network (e.g., a utility company, a governmental body, distributor, a retailer, manufacturer, etc.), or may be hosted in a cloud environment, or a combination of privately hosted and cloud hosted services.

Each of the computing devices described herein may include one or more processors and/or memory. Specifically, in the illustrated example, the first platform 1502a and/or the second platform 1502b include, respectfully, one or more processors 1504a and 104b and memory 1512a and 1512b, the first computing device 1504 includes one or more processors 1514 and memory 1516, the second computing device 1506 includes one or more processors 1518 and memory 1520. By way of example and not limitation, the processor(s) may comprise one or more Central Processing Units (CPUs), Graphics Processing Units (GPUs), or any other device or portion of a device that processes electronic data to transform that electronic data into other electronic data that may be stored in registers and/or memory. In some examples, integrated circuits (e.g., ASICs, etc.), gate arrays (e.g., FPGAs, etc.), and other hardware devices may also be considered processors in so far as they are configured to implement encoded instructions.

The memory may comprise one or more non-transitory computer-readable media and may store an operating system and one or more software applications, instructions, programs, and/or data to implement the methods described herein and the functions attributed to the various systems. In various implementations, the memory may be implemented using any suitable memory technology, such as static random-access memory (SRAM), synchronous dynamic RAM (SDRAM), nonvolatile/Flash-type memory, or any other type of memory capable of storing information. The architectures, systems, and individual elements described herein may include many other logical, programmatic, and physical components, of which those shown in the accompanying figures are merely examples that are related to the discussion herein.

As shown in FIG. 15, the first platform 1502a and/or the second platform 1502b respectfully includes a social networking application 1526a and 1526b, the first computing device 1504 includes social network client application 1528, and the second computing device 1506 includes social network client application 1530 that enables interaction of content among the computing devices via the first platform 1502a and/or the second platform 1502b. For example, content (e.g., text, images, audio, video, GIFs, emojis, and/or the like associated with posts, comments to posts, direct messages, etc.) can be shared among users associated with social networking accounts (e.g., user accounts 1534a and/or 1534b) of an online social network provided by the social networking system and may include sharing content in accordance with a user account of a user that is restricted. In various examples, data associated with user accounts of users of the social networking system may be stored in association with the social networking application 1526a and/or 1526b, such as in the user accounts 1534a and/or 1534b. In some examples, the user accounts 1534a and/or 1534b may be personal accounts associated with an individual user or business accounts associated with a business of a user (e.g., merchant accounts). In some examples, the messaging client application enables interfaces to access content, to view content, and to generate content as those described with reference to FIGS. 2-14, for example. In particular examples, first platform 1502a and/or the second platform 1502b sends instructions to present, transmit, and receive content as discussed with reference to FIGS. 2-14.

FIG. 10 further illustrates first platform 1502a and/or the second platform 1502b as including sticker customization components 1532a and 1532b, respectfully, to enable functionality with regard to customizing sticker, as described herein. For example, the sticker customization component may include functionality associated with customizing stickers associated with a first user of a first account and a second user of a second account.

In various examples, the sticker customization components 1532a and/or 1532b may be configured to designate the first account and/or the second account as contributors to the customized sticker. As described above, as creators of the customized sticker, the first account and/or the second account may generate a customized sticker. In some examples, the content may be presented to other user accounts via a display of a computing device associated with the other accounts.

As shown in FIG. 15, first platform 1502a and/or the second platform 1502b include communications connection(s) 1542a and 1542b, respectfully, the first computing device 1504 includes communications connection(s) 1544, and the second computing device 1506 includes communications connection(s) 1546 that enables communication between two or more of the first platform 1502a and/or the second platform 1502b, the first computing device 1504, and the second computing device(s) 1506, and/or additional computing device(s).

The communication connection(s) 1542a, 1542b, 1544, and/or 1546, can include physical and/or logical interfaces for connecting the first platform 1502a and/or the second platform 1502b, the first computing device 1504, and/or the second computing device 1506 to another computing device or a network, such as network(s) 108. For example, the communications connection(s) 1542a, 1542b, 1544, and/or 1546 can enable Wi-Fi-based communication such as via frequencies defined by the IEEE 802.10 standards, short range wireless frequencies such as Bluetooth®, cellular communication (e.g., 2G, 2G, 4G, 4G LTE, 5G, etc.) or any suitable wired or wireless communications protocol that enables the respective computing device to interface with the other computing device(s).

While FIG. 15 is provided as an example system 1500 that can be used to implement techniques described herein, the techniques described and claimed are not limited to being performed by the system 1500, nor is the system 1500 limited to performing the techniques described herein.

### CONCLUSION

Although the discussion above sets forth example implementations of the described techniques, other architectures may be used to implement the described functionality, and are intended to be within the scope of this disclosure. Furthermore, although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

What is claimed is:

1. A method comprising:
causing presentation, via a first interface, of a sticker tray associated with an account of a social networking system;
receiving, from the account, indication of a selection of a sticker in the sticker tray;
causing presentation, based at least in part on the selection of the sticker, of an option to modify the sticker;
receiving, from the account, indication of a selection to modify the sticker;
causing presentation, based at least in part on the selection to modify the sticker, of a second interface, the second interface including a control usable to modify the sticker;
receiving user input via the control to modify the sticker; and
storing the one or more modifications in association with a modified sticker in the sticker tray.

2. The method of claim 1, wherein the account is a first account, the method further comprising:
receiving, from the first account, an indication to add the modified sticker to a content item; and
causing presentation, via a display of computing device associated with a second account of the social networking system, of the content item including the modified sticker.

3. The method of claim 2, wherein the content item includes an item of ephemeral content.

4. The method of claim 1, wherein the one or more modifications include a change to at least one of:
a size of the sticker;
a font of the sticker;
a color of the sticker;
an animation of the sticker; or
a song associated with the sticker.

5. The method of claim 1, wherein the account is a first account, the method further comprising:
storing the one or more modifications as a preference of the first account;
generating, based at least in part on the one or more modifications, one or more preferred stickers; and
storing the one or more preferred stickers in the sticker tray, the one or more preferred stickers to be shared with a second account of the social networking system.

6. The method of claim 5, wherein the one or more modifications include a change to an element of the sticker, and the one or more preferred stickers include the one or more changed elements.

7. The method of claim 5, wherein the preference is a first preference, the method further comprising:
determining an interaction between the first account and a second content item;
determining a category associated with the second content item; and
determining, based at least in part on the interaction, a second preference, wherein the second preference is associated with the category,
wherein generating the one or more preferred stickers is based at least in part on the second preference.

8. The method of claim 1, wherein the account is a first account and the content item is a first content item, the method further comprising:
receiving, from the first account, an indication to share the modified sticker;
receiving, from the first account, an indication to send the modified sticker to a second account of the social networking system;
sending the modified sticker to the second account;
adding the modified sticker to a sticker tray associated with the second account;
receiving, from the second account, an indication to add the modified sicker to a second content item; Cause and
causing presentation, via a display of a computing device associated with a third account of the social networking system, of the second content item including the modified sticker.

9. The method of claim 8, further comprising:
causing presentation, to the first account via the first interface and based at least in part on receiving an indication to send the modified sticker to second account, a selectable icon enabling the first account to limit an amount of time that the modified sticker is accessibly by the second account; and
receiving, from the first account, an indication of an amount of time;
wherein causing presentation of the content item via the display of a computing device associated with a third account is based at least in part on the amount of time.

10. A system comprising:
one or more processors; and
one or more computer-readable media storing instructions that, when executed by the one or more processors, perform operations comprising:
causing presentation, via a first interface, of a sticker tray associated with an account of a social networking system;
receiving, from the account, indication of a selection of a sticker in the sticker tray;
causing presentation, based at least in part on the selection of the sticker, of an option to modify the sticker;
receiving, from the account, indication of a selection to modify the sticker;
causing presentation, based at least in part on the selection to modify the sticker, of a second interface, the second interface including a control usable to modify the sticker;
receiving user input via the control to modify the sticker; and
storing the one or more modifications in association with a modified sticker in the sticker tray.

11. The system of claim 10, wherein the account is a first account, the operations further comprising:
receiving, from the first account, an indication to add the modified sticker to a content item; and
causing presentation, via a display of a computing device associated with a second account of the social networking system, of the content item including the modified sticker.

12. The system of claim 10, wherein the content item includes an item of ephemeral content.

13. The system of claim 10, wherein the one or more modifications include a change to at least one of:
a size of the sticker;
a font of the sticker;
a color of the sticker;
an animation of the sticker; or
a song associated with the sticker.

14. The system of claim 10, wherein the account is a first account, the operations further comprising:
storing the one or more modifications as a preference of the first account;
generating, based at least in part on the one or more modifications, one or more preferred stickers; and
storing the one or more preferred stickers in the sticker tray, the one or more preferred stickers to be shared with a second account of the social networking system.

15. The system of claim 14, wherein the one or more modifications include a change to an element of the sticker, and the one or more preferred stickers include the one or more changed elements.

16. The system of claim 14, wherein the preference is a first preference, the operations further comprising:
determining an interaction between the first account and a second content item;
determining a category associated with the second content item; and
determining, based at least in part on the interaction, a second preference, wherein the second preference is associated with the category,
wherein generating the one or more preferred stickers is based at least in part on the second preference.

17. One or more computer-readable media storing instructions that, when executed by one or more processors, perform operations comprising:
causing presentation, via a first interface, of a sticker tray associated with an account of a social networking system;
receiving, from the account, indication of a selection of a sticker in the sticker tray;
causing presentation, based at least in part on the selection of the sticker, of an option to modify the sticker;
receiving, from the account, indication of a selection to modify the sticker;
causing presentation, based at least in part on the selection to modify the sticker, of a second interface, the second interface including a control usable to modify the sticker;
receiving user input via the control to modify the sticker; and
storing the one or more modifications in association with a modified sticker in the sticker tray.

18. The one or more computer-readable media of claim 17, wherein the account is a first account, the operations further comprising:
receiving, from the first account, an indication to share the modified sticker;
receiving, from the first account, an indication to send the modified sticker to a second account of the social networking system;
sending the modified sticker to the second account;
adding the modified sticker to a sticker tray associated with the second account;
receiving, from the second account, an indication to add the modified sicker to a content item; and
causing presentation, via a display of a computing device associated with a third account of the social networking system, of the content item including the modified sticker.

19. The one or more computer-readable media of claim 18, the operations further comprising:
causing presentation, to the first account via the first interface and based at least in part on receiving an indication to send the modified sticker to second account, a selectable icon enabling the first account to limit an amount of time that the modified sticker is accessibly by the second account; and
receiving, from the first account, an indication of an amount of time;
wherein causing presentation of the content item via the display of a computing device associated with a third account is based at least in part on the amount of time.

20. The one or more computer-readable media of claim 17, wherein the account is a first account, the operations further comprising:
receiving, from the first account, an indication to add the modified sticker to a content item; and
causing presentation, via a display of a computing device associated with a second account of the social networking system, of the content item including the modified sticker.
